(19) United States
(12) Patent Application Publication
(10) Pub. No.: US 2017/0346945 A1
(43) Pub. Date: Nov. 30, 2017

(54) METHODS FOR MANAGING COMMUNICATION NOTE DURING CALL AND ELECTRONIC DEVICE THEREOF

(71) Applicant: Samsung Electronics Co., Ltd., Suwon-si (KR)

(72) Inventors: Lucky NARANG, Chandrapur (IN); Vinit SHUKLA, Bhadohi (IN); Jitendra DOGRA, Noida (IN)

(21) Appl. No.: 15/606,734

(22) Filed: May 26, 2017

(30) Foreign Application Priority Data
May 27, 2016 (IN) 201641018340

(51) Int. Cl. H04M 3/42; H04M 3/436

(52) U.S. Cl. CPC H04M 3/42382; H04M 3/4365

(57) ABSTRACT

The embodiments herein provide a method for managing communication notes during a call at an electronic device. The method includes detecting the call associated with a contact stored in the electronic device. Further, the method includes retrieving at least one communication note comprising at least one data item for the contact. Further, the method includes causing to display the at least one communication note on a screen of the electronic device while the call is ongoing, wherein the at least one communication note is associated with an indicia indicating a priority level.

### CROSS-REFERENCE TO RELATED APPLICATION(S)

This application claims the benefit under 35 U.S.C. §119(a) of an Indian patent application filed on May 27, 2016 in the Indian Patent Office and assigned Serial number 201641018340, the entire disclosure of which is hereby incorporated by reference.

### TECHNICAL FIELD

The present disclosure relates to electronic devices. More particularly, the present disclosure relates to a mechanism for managing communication note during a call at an electronic device.

### BACKGROUND

Communication devices such as smart phones are available that allow users to create and save electronic notes while a call is ongoing. Most of the times, a user think in prior to an incoming call or an outgoing call about conversation or important agenda that he/she will talk during the call when it is being made or received. But the user forgets some conversation points during the call and makes him in recalling situation. In an example, consider a scenario where the user actually receives or makes the call with a contact stored in the electronic device. If the call is established, then the user forgets to discuss some topics what the user has pre-thought to discuss while the call is ongoing. In order to convey the information, the user has to make the call for discussing the remaining points which the user skipped to discuss during the initial discussion over the call.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a mechanism for managing communication note during a call at an electronic device.

Another object of the embodiments herein is to provide a mechanism for detecting the call associated with a contact stored in the electronic device.

Another object of the embodiments herein is to provide a mechanism for retrieving at least one communication note including at least one data item for the contact.

Another object of the embodiments herein is to provide a mechanism for causing to display the at least one communication note on a screen of the electronic device while the call is ongoing, where the at least one communication note is associated with an indicia indicating a priority level.

Another object of the embodiments herein is to provide a mechanism for detecting an input event on the electronic device.

Another object of the embodiments herein is to provide a mechanism for displaying the at least one communication note on a wearable device.

Yet another object of the embodiments herein is to provide a mechanism for detecting the call between a first electronic device and a second electronic device.

Yet another object of the embodiments herein is to provide a mechanism for retrieving a first communication note including the at least one data item from the first electronic device and a second communication note including the at least one data item from the second electronic device.

Yet another object of the embodiments herein is to provide a mechanism for causing to display the first communication note and the second communication note on the screen of the first electronic device and on a screen of the second electronic device while the call is ongoing, where at least one of the first communication note and the second communication note is associated with an indicia indicating the priority level.

Accordingly the embodiments herein provide a method for managing communication note during a call at an electronic device. The method includes detecting the call associated with a contact stored in the electronic device. Further, the method includes retrieving at least one communication note including at least one data item for the contact. Further, the method includes causing to display the at least one communication note on a screen of the electronic device while the call is ongoing, where the at least one communication note is associated with an indicia indicating a priority level.

In an embodiment, the method further includes detecting the at least one data item discussed by a user of the electronic device while the call is ongoing. Further, the method includes dynamically discarding the at least one data item discussed while the call is ongoing from the at least one communication note.

In an embodiment, the method further includes detecting the at least one data item discussed by the user of the electronic device while the call is ongoing. Further, the method includes dynamically adding the at least one data item discussed while the call is ongoing in the at least one communication note.

In an embodiment, the method further includes detecting an input event while the call is ongoing. Further, the method includes causing to display an editing unit on the screen of the electronic device. Further, the method includes receiving at least one data item from the editing unit while the call is ongoing. Further, the method includes dynamically adding the at least one received data item in the at least one communication note.

In an embodiment, the at least one communication note is automatically retrieved from a communication note inventory hosted one of locally and remotely.

In an embodiment, the priority level is dynamically defined based on at least one of an amount of data items inputted by the user and a type of data items.

In an embodiment, the at least one date item in the at least one communication note is displayed based on at least one display event while the call is ongoing, where the display event is dynamically defined based on at least one of a glide event, a proximity event, a time event, and a priority level.

In an embodiment, the at least one date item in the at least one communication note is displayed based on at least one of a gesture event while the call is ongoing, where the gesture event is one of the glide event and the proximity event.

In an embodiment, at least one parameter of the at least one communication note is dynamically defined based on one of a type of the at least one of data item and an amount of the at least one data item, where the parameter includes a position, a size, a shape, a color, a category, an opacity level, and a background.

Accordingly the embodiments herein provide a method for managing communication note during a call. The method includes detecting the call between a first electronic device and a second electronic device. Further, the method includes retrieving a first communication note including at least one data item from the first electronic device and a second communication note including at least one data item from the second electronic device. Further, the method includes causing to display the first communication note and the second communication note on a screen of the first electronic device and on a screen of the second electronic device while the call is ongoing, where at least one of the first communication note and the second communication note is associated with an indicia indicating a priority level.

In an embodiment, the first communication note and the second communication note are dynamically switched based on a glide event performed by the user.

In an embodiment, the method further includes detecting at least one of data items from the first communication note discussed while the call is ongoing and data items from the second communication note discussed while the call is ongoing. Further, the method includes dynamically discarding at least one of the data items discussed while the call is ongoing from the first communication note and the data items discussed while the call is ongoing from the second communication note.

In an embodiment, the method includes detecting whether the call is disconnected. Further, the method includes identifying at least one of remaining data items not discussed while the call was ongoing from the first communication note and remaining data items not discussed while the call was ongoing from the second communication note. Further, the method includes sending at least one message including at least one of the remaining data items from the first communication note to the second electronic device and the remaining data items from the second communication note to the first electronic device.

In an embodiment, the method includes detecting a third data item discussed while the call is ongoing. Further, the method includes dynamically adding the third data item in at least one of the first communication note and the second communication note.

In an embodiment, the priority level is dynamically defined based on at least one of an amount of data items inputted by a user and a type of data items.

Accordingly the embodiments herein provide a system for managing communication note during a call. The system includes an electronic device coupled to a wearable device, configured to detect the call associated with a contact stored in the electronic device. Further, the electronic device is configured to retrieve at least one communication note including at least one data item for the contact. Further, the electronic device is configured to cause to display the at least one communication note on a screen of the electronic device while the call is ongoing. Further, the electronic device is configured to detect an input event on the electronic device. Further, the electronic device is configured to display the at least one communication note on the wearable device.

In an embodiment, the electronic device configured to detect an input event in the electronic device. Further, the electronic device is configured to dynamically perform at least one action on the at least one communication note displayed on the wearable device.

Accordingly the embodiments herein provide an electronic device for managing communication note during a call. The electronic device includes a memory, a processor, and a communication note manager, coupled to the memory and the processor. The communication note manager is configured to detect the call associated with a contact stored in the electronic device. Further, the communication note manager is configured to retrieve at least one communication note including at least one data item for the contact. Further, the communication note manager is configured to cause to display the at least one communication note on a screen of the electronic device while the call is ongoing, where the at least one communication note is associated with an indicia indicating a priority level.

Accordingly the embodiments herein provide a system for managing communication note during a call. The system includes a communication note manager configured to detect the call between a first electronic device and a second electronic device. Further, the communication note manager is configured to retrieve a first communication note including at least one data item from the first electronic device and a second communication note including at least one data item from the second electronic device. Further, the communication note manager is configured to cause to display the first communication note and the second communication note on a screen of the first electronic device and on a screen of the second electronic device while the call is ongoing, where at least one of the first communication note and the second communication note is associated with an indicia indicating a priority level.

Accordingly the embodiments herein provide a computer program product including a computer executable program code recorded on a computer readable non-transitory storage medium. The computer executable program code when executed causing the actions including detecting a call associated with a contact stored in an electronic device. Further, the computer executable program code when executed causing the actions including retrieving at least one communication note including at least one data item for the contact. Further, the computer executable program code when executed causing the actions including causing to display the at least one communication note on a screen of the electronic device while the call is ongoing, where the at least one communication note is associated with an indicia indicating a priority level.

Accordingly the embodiments herein provide a computer program product including a computer executable program code recorded on a computer readable non-transitory storage medium. The computer executable program code when executed causing the actions including detecting a call between a first electronic device and a second electronic device. Further, the computer executable program code when executed causing the actions including retrieving a first communication note including at least one data item from the first electronic device and a second communication note including at least one data item from the second electronic device. Further, the computer executable program code when executed causing the actions including causing to display the first communication note and the second communication note on a screen of the first electronic device and on a screen of the second electronic device while the call is ongoing, where at least one of the first communication note and the second communication note is associated with an indicia indicating a priority level.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a system for managing a communication note, according to an embodiment of the present disclosure;

FIG. 2 is a flow diagram illustrating a method for drafting a communication note for a contact prior to a call, according to an embodiment of the present disclosure;

FIG. 3 shows an example illustration in which a communication note is created and assigned to a contact stored in a phonebook prior to a call, according to an embodiment of the present disclosure;

FIG. 4 shows an example illustration in which a shape of a communication note is varied based on a type of data item(s), according to an embodiment of the present disclosure;

FIG. 5 shows an example illustration of a contact screen showing contacts and a symbol in the form of a communication note image, according to an embodiment of the present disclosure;

FIGS. 6A and 6B are a flow diagram illustrating a method for managing a communication note in an electronic device, according to an embodiment of the present disclosure;

FIGS. 7A and 7B show an example illustration in which a communication note is displayed on a screen when a user receives an incoming call, according to an embodiment of the present disclosure;

FIGS. 8A to 8C show an example illustration in which a communication note is displayed on a screen of an electronic device when a user makes an outgoing call, according to an embodiment of the present disclosure;

FIGS. 9A to 9D show an example illustration in which a communication note is displayed on a screen when a user makes an outgoing call through a messaging application, according to an embodiment of the present disclosure;

FIG. 10 shows an example illustration in which a new data item discussed by a user is added into a communication note while a call is ongoing, according to an embodiment of the present disclosure

FIGS. 11A and 11B show an example illustration in which content is dynamically discarded from a communication note when a user discusses the content while a call is ongoing, according to an embodiment of the present disclosure;

FIG. 12 shows an example illustration in which remaining data items are sent through a message when a call is disconnected, according to an embodiment of the present disclosure;

FIGS. 13A and 13B are a flow diagram illustrating a method for managing a communication note, according to an embodiment of the present disclosure;

FIG. 14 shows an example illustration in which a first communication note and a second communication note are displayed on a screen of a first electronic device, according to an embodiment of the present disclosure;

FIG. 15 is a flow diagram illustrating a method for dynamically performing an action on a communication note displayed on a wearable device, according to an embodiment of the present disclosure;

FIG. 16 shows an example illustration in which discussion points in a communication note displayed on a wearable device are flipped when a user blocks a proximity sensor of an electronic device, according to an embodiment of the present disclosure;

FIG. 17 is a flow diagram illustrating a method for dynamically adding received data item in a communication note, according to an embodiment of the present disclosure;

FIG. 18 shows an example illustrating in which a communication note is edited while a call is ongoing, according to an embodiment of the present disclosure;

FIG. 19 shows an example illustration in which a Social Networking Site (SNS) based suggestions is displayed on a communication note when the communication note for a contact is not drafted, according to an embodiment of the present disclosure;

FIG. 20 illustrates a system for implementing the communication note, according to an embodiment of the present disclosure;

FIG. 21 illustrates a sequence diagram of scheme for implementing the communication note an embodiment of the present disclosure;

FIG. 22 is a flow diagram illustrating a method for implementing the communication note, according to an embodiment of the present disclosure;

FIG. 23 is a flow diagram illustrating a method for implementing the communication note in the dual mode display of the communication note, according to an embodiment of the present disclosure;

FIG. 24 illustrates a system for implementing voice contextual discarding to an embodiment of the present disclosure;

FIG. 25 is a flow diagram illustrating a method for implementing the voice contextual discarding, according to an embodiment of the present disclosure; and

FIG. 26 illustrates a system for implementing the communication note with wearable device, according to an embodiment of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The labels “First”, “Second”, and “Third”, are used merely for illustrative purpose only.

Accordingly the embodiments herein provide a method for managing communication note during a call at an electronic device. The method includes detecting the call associated with a contact stored in the electronic device. Further, the method includes retrieving at least one communication note including at least one data item for the contact. Further, the method includes causing to display the at least one communication note on a screen of the electronic device while the call is ongoing, where the at least one communication note is associated with an indicia indicating a priority level.

Accordingly the embodiments herein provide a method for managing communication note during the call. The method includes detecting the call between a first electronic device and a second electronic device. Further, the method includes retrieving a first communication note including the at least one data item from the first electronic device and a second communication note including the at least one data item from the second electronic device. Further, the method includes causing to display the first communication note and the second communication note on a screen of the first electronic device and on a screen of the second electronic device while the call is ongoing, where at least one of the first communication note and the second communication note is associated with the indicia indicating the priority level.

Unlike conventional systems and methods, the proposed mechanism facilitates the user with a way to enclose at least one discussion point (i.e., at least one data item) in the form of at least one communication note. The communication note(s) can be editable as and when required by the user prior to an incoming call or an outgoing call. Further, the communication note can be dynamically invoked based on a priority level associated with the communication note during the call for effective and summarized communication. Further, the proposed mechanism facilitates the user with an option to have complete conversation during the call using the prioritized communication notes. Further, the communication note works as an aid for effective and summarized call by associating the communication note with the contact.

The conventional mechanisms disclose a method which helps the user to take important points during the call for gathering information or saving call information. In the proposed mechanism, the communication note is drafted prior to receiving or making the call from/to the contact stored in the electronic device. Further, the display of the communication note is decided based on the priority level. Further, in the proposed mechanism, the priority based communication notes are displayed and can disappear after showing previously saved important communication notes during the call. If the priority time limit is not completed and the call is disconnected, then remaining information (i.e., data items) in the communication note are sent through the message (For example: Text message) to complete the communication with the contact. Further, the communication notes are updated based on user's voice context. The discussion points (i.e., data items) of the communication notes are being discarded as and when the user speaks about the discussion points during the call.

Unlike conventional systems and methods, the proposed mechanism can be used to capture information (i.e., data items) as and when it lingers in the mind of the user through the communication note prior to the call. Further, the communication note can be assigned with the priority level to render the communication note on the screen of the electronic device as a discussion reminder while the call is ongoing for effective purpose usage.

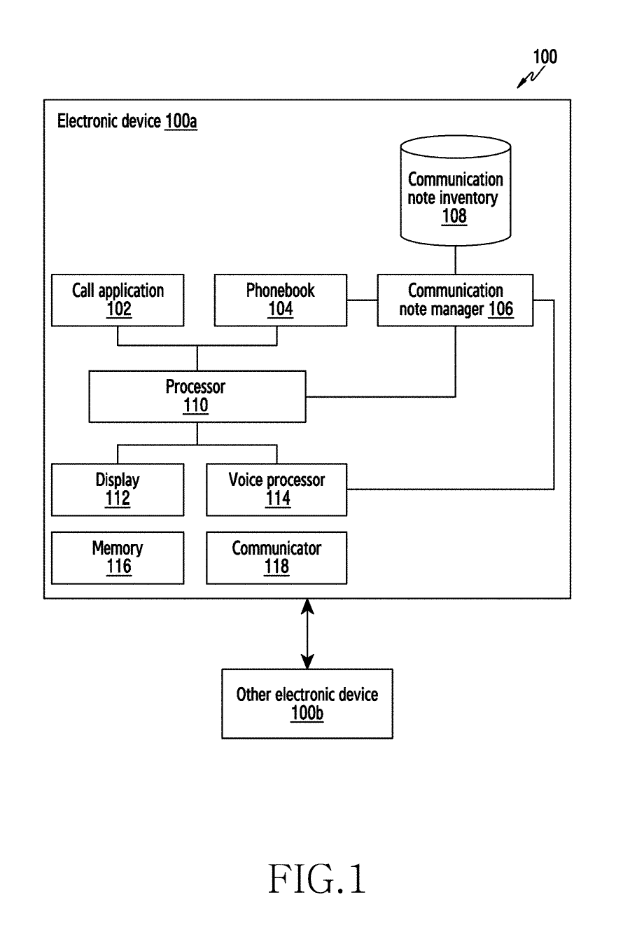

Referring now to the drawings, and more particularly to FIGS. 1 through 26, where similar reference characters denote corresponding features consistently throughout the figures, there are shown preferred embodiments.

FIG. 1 illustrates a system 100 for managing a communication note, according to an embodiment of the present disclosure. In an embodiment, the system 100 includes an electronic device 100a and other electronic device 100b. In an embodiment, the electronic device 100a and the other electronic device 100b can be, for example, a laptop, a desktop computer, a mobile phone, a smart phone, Personal Digital Assistants (PDAs), a tablet, a phablet, a consumer electronic device, a dual display device, or any other electronic device. In another embodiment, the other electronic device 100b can be a wearable device. The wearable device can be, for example, a smart watch, a smart bracelet, a smart glass, or the like. The electronic device 100a includes a call application 102, a phonebook 104, a communication note manager 106, a communication note inventory 108, a processor 110, a display 112, a voice processor 114, a memory 116, and a communicator 118. Initially, single or multiple communication notes (For example: Electronic notes) can be drafted with a contact stored in the electronic device 100a prior to receiving an incoming call from the contact or making an outgoing call to the contact. The call application 102 allows a user to make or receive calls. The processor 110 can include the communication note manager 106, a telephony manager 2030, an audio manager, and so on.

The phonebook 104 includes details of the contact (i.e., single contact or multiple contacts) stored in the memory 116 of the electronic device 100a. Contact information may have same meaning as the contact. The communication note manager 106 can be configured to detect the call associated with the contact stored in the electronic device 100a. Further, the communication note manager 106 can be configured to retrieve communication note(s) including data item(s) for the contact. In an example, the data items can be, for example, discussion points, discussion agenda, and information to be discussed with the contact while the call is ongoing. In an embodiment, the communication note is automatically retrieved from the communication note inventory 108 of the electronic device 100a. In another embodiment, the communication note is automatically retrieved from a communication note inventory which is located remotely. In an example, the communication note is automatically retrieved from the communication note inventory of another electronic device (For example: other electronic device 100b) which is located remotely away from the electronic device 100a. In an embodiment, at least one parameter of the communication note is dynamically defined based on a type of the data item or amount of the data items. The parameter includes a position, a size, a shape, a color, a category, an opacity level, and a background.

Further, the communication note manager 106 can be configured to cause to display the communication note on the display 112 (i.e., screen) of the electronic device 100a while the call is ongoing. In an embodiment, the communication note is associated with indicia indicating a priority level. The priority level is dynamically defined based on an amount of the data items inputted by a user, the type of data items, or combination of same. In an embodiment, the data item in the communication note is displayed based on a display event while the call is ongoing. The display event is dynamically defined based on a glide event, a proximity event, a time event, a priority level, or combination of same. In another embodiment, the date item in the communication note is displayed based on at least one gesture event while the call is ongoing, where the gesture event is the glide event or the proximity event.

In an example, the communication notes are categorized based on the priority level of the information included in the communication note. The priority level can be High, Medium, or Low. Each of the communication notes is displayed with different dual color scheme (i.e., category color scheme and priority color scheme) on the screen of the electronic device 100a thus, providing priority details to the user. Further, the duration for which the communication note is displayed on the screen depends on the priority level. Some of the example priority level are described below:
a. High Priority Level: The High priority level communication note has limited content and is displayed on the screen of the electronic device 100a just after 5 seconds of the call duration, if the communication note is not opened by the user after seeing the high priority color floating button on the calling screen. Further, the communication note with High priority level is displayed for a minimum of 1 minute on the screen of the electronic device 100a.
b. Medium Priority Level: The Medium priority level communication note has more content included when compared to the communication note with the High priority level. The communication note with the Medium priority level is automatically opened after 10 seconds of the call duration if it is not opened by the user after seeing the Medium priority color floating button on the screen of the electronic device 100a. Further, the communication note is displayed minimum of 3 minutes on the screen.
c. Low Priority Level: The communication notes with the Low priority level can have maximum number of content. This is not opened automatically and displayed on the screen. The user must open the communication note after seeing the Low priority floating button over the calling screen.

Further, in an embodiment, the communication note manager 106 can be configured to detect the data item discussed by the user of the electronic device 100a using the voice processor 114 while the call is ongoing. After detecting the data item, the voice processor 114 sends the detected data item to the communication note manager 106. On receiving the data item, the communication note manager 106 can be configured to dynamically discard the data item from the communication note discussed while the call is ongoing. In another embodiment, the communication note manager 106 can be configured to detect data item(s) (i.e., new data item(s)) discussed by the user while the call is ongoing. Further, the communication note manager 106 can be configured to dynamically add the new data item discussed while the call is ongoing in the communication note.

In an embodiment, the communication note manager 106 can be configured to detect an input event while the call is ongoing. Further, the communication note manager 106 can be configured to cause to display an editing unit (not shown) on the display 112 of the electronic device 100a. Further, the communication note manager 106 can be configured to receive data item(s) from the editing unit while the call is ongoing. Further, the communication note manager 106 can be dynamically add the received data item in the communication note. The communication note inventory 108 can be configured to store the communication notes for various contacts stored in the electronic device 100a. Further, the communication note inventory 108 can be implemented in the form of SQL LITE or XML (libxml3). In an example, the communication note inventory 108 limits the entries of 10 communication notes with a single contact number. Further, the communication note inventory 108 includes 3 tables as shown below:

TABLE 1

| | No. of | |
|---|---|---|
| Contact | communication | ID (Primary |
| Number | notes | key) |
| [symbol] | [symbol] | [symbol] |

[symbol]

indicates data missing or illegible when filed

TABLE 2

| ID | | | Type | When |
|---|---|---|---|---|
| (Foreign | Communication | Date/ | ID (foreign | To |
| Key) | Notes | Time | Key) | Delete |
| [symbol] | [symbol] | [symbol] | [symbol] | [symbol] |

[symbol]

indicates data missing or illegible when filed

TABLE 3

| Type | Type ID |
|---|---|
| Description | (Primary Key) |
| Pre-Defined | 1 |
| Run-Time | 2 |

The functionalities of the communication note manager 106 can be performed by the processor 110 without departing from the scope of invention.

The memory 116 can be configured to store the communication note associated with the contact. The memory 116 may include one or more computer-readable storage media. The memory 116 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 116 may, in some examples, be considered a non-transitory storage medium. The term “non-transitory” may indicate that the storage medium is not embodied in a carrier wave or a propagated signal. However, the term “non-transitory” should not be interpreted that the memory 116 is non-movable. In some examples, the memory 116 can be configured to store larger amounts of information than the memory. In certain examples, a non-transitory storage medium may store data that can, over time, change (e.g., in Random Access Memory (RAM) or cache). The communicator 118 communicates internally with the units and externally with networks.

Unlike conventional systems and methods, the proposed mechanism enhances the overall user experience thus, dynamically invoking the communication note when the call is arrived and displayed over a call screen for either or both of caller (i.e., user) and called parties (i.e., contact). Further, the dynamic update of the communication note size and content based on a voice recognition subsystem makes it intelligent and smart feature. Unlike conventional systems and methods, the proposed mechanism can be used to share the remaining content through the message completing the communication.

In an example, consider a scenario where the incoming call is being received, prior to answering the call, the communication note which is drafted is queried from the communication note inventory 108. The communication note floating button is popped up over the incoming call screen, which can be glided by the user by performing the gesture event to view the contents (i.e., data items) which are drafted prior to the call. In an example, the communication notes has various characteristics associated with the parameters such as the shape, the color, the size, the position of the communication note floating button over the call screen, and the transparency of the communication note. Further, the parameters can be altered via settings based on the context of the content.

Further, the transparent communication notes can be of various types based on the contents the user needs to draft. The color indicates the type of the communication note. Some example communication notes are described below:
d. Official communication note in a blue color.
e. Buddy communication in a yellow color.
f. Relationship communication note in a purple or pink color.
g. Conference communication note in a violet color.

In an embodiment, the communication notes can be also applicable to other applications such as messages in the form of a communication notes box, an email application, a Social Networking Site (SNS) application, or the like. Further, the display of the communication note and composition format varies as per different types of the communication notes.

In an embodiment, most of the times it happens that due to skipping of the discussion topics (i.e., data items) from the mind of the user about the conversation during the call. The user has to make the call again to discuss about the skipped discussion points with the contact. Unlike conventional systems and methods, the proposed mechanism helps the user in drafting the communication note which helps in minimizing the re-calling situations and making the conversation effective.

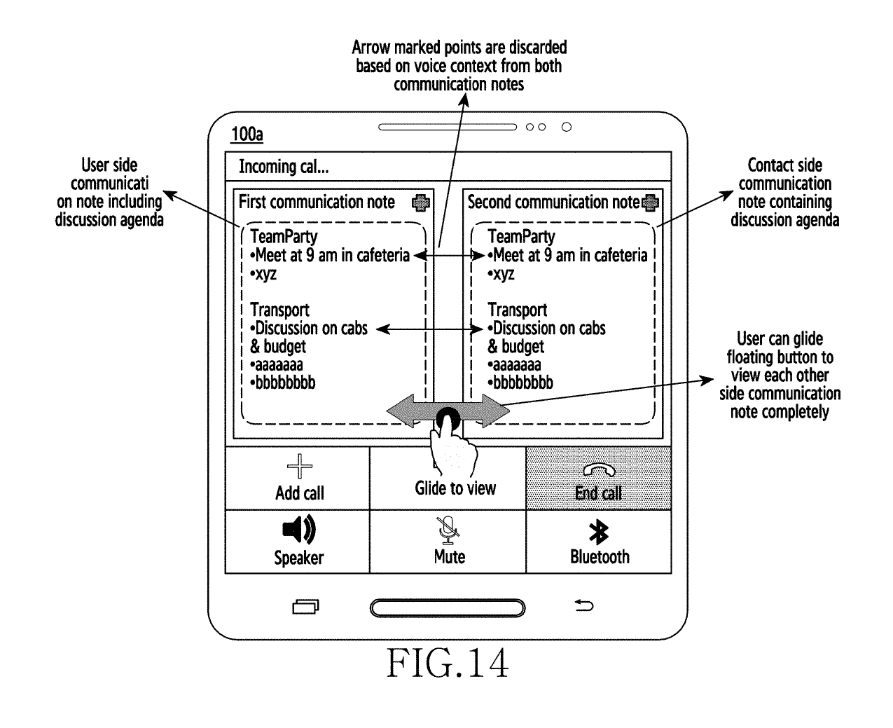

In an embodiment, the communication note manager 106 can be configured to detect the call between the electronic device 100a (i.e., first electronic device 100a) and other electronic device 100b (i.e., the second electronic device 100b). Further, the communication note manager 106 can be configured to retrieve a first communication note including the data item from the first electronic device 100a and a second communication note including the data item from the second electronic device 100b. Further, the communication note manager 106 can be configured to cause to display the first communication note and the second communication note on the screen of the first electronic device 100a and on a screen of the second electronic device 100b while the call is ongoing, where at least one of the first communication note and the second communication note is associated with the indicia indicating the priority level. The priority level is dynamically defined based on the amount of data items inputted by the user, the type of data items, or combination of same. In an embodiment, the first communication note and the second communication note are dynamically switched based on the glide event performed by the user. The example illustration of the glide event is explained in conjunction with FIG. 14.

In an embodiment, the communication note manager 106 can be configured to detect the data items from the first communication note discussed while the call is ongoing and the data items from the second communication note discussed while the call is ongoing. Further, the communication note manager 106 can be configured to dynamically discard at least one of the data items discussed while the call is ongoing from the first communication note and the data items discussed while the call is ongoing from the second communication note.

In an embodiment, the communication note manager 106 can be configured to detect whether the call is disconnected. Further, the communication note manager 106 can be configured to identify at least one of remaining data items not discussed while the call was ongoing from the first communication note and remaining data items not discussed while the call was ongoing from the second communication note. Further, the communication note manager 106 can be configured to send the message including at least one of the remaining data items from the first communication note to the second electronic device 100b, and the remaining data items from the second communication note to the first electronic device 100a. In an embodiment, the communication note manager 106 can be configured to detect a third data item discussed while the call is ongoing. Further, the communication note manager 106 can be configured to dynamically add the third data item in at least one of the first communication note and the second communication note.

In an embodiment, the electronic device 100a can be configured to detect the input event on the electronic device 100a; and display the communication note on the wearable device 100b. Further, the electronic device 100a can be configured to detect an input event in the electronic device 100a. Further, the electronic device 100a can be configured to dynamically perform at least one action on the communication note displayed on the wearable device 100b.

The FIG. 1 shows a limited overview of the system 100 but, it is to be understood that another embodiment is not limited thereto. Further, the system 100 can include different units communicating among each other along with other hardware or software components. By way of illustration, both an application running on a system 100 and the system 100 can be the component.

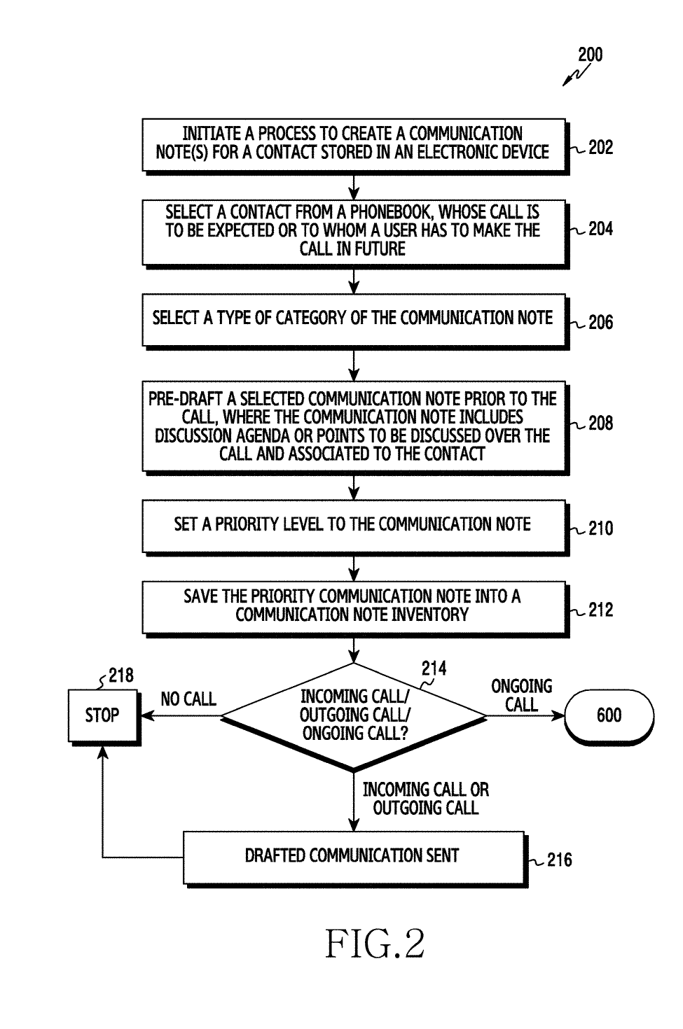

FIG. 2 is a flow diagram 200 illustrating a method for drafting the communication note for the contact prior to the call, according to an embodiment of the present disclosure. FIG. 2 exemplifies a method for operating the electronic device 110a

Referring FIG. 2, at step 202, the electronic device (i.e., the communication note manager 106 or the processor 110) initiates a process to create the communication note for the contact stored in the electronic device 100a. At step 204, the electronic device selects the contact from the phonebook 104 (i.e., address book), whose call is to be expected or to whom the user has to make the call in future.

At step 206, the electronic device selects a type of category of the communication note. In an embodiment, the type of communication note can be the official communication note, the buddy communication note, the relationship communication note, and the conference communication note. In an example, the official communication note can be indicated with the blue color. The buddy communication note can be indicated with the yellow color, the relationship communication note can be indicated with the purple color, and the conference communication note can be indicated with the violet color.

At step 208, the electronic device pre-drafts a selected communication note prior to the call, where the communication note includes discussion agenda or points to be discussed over the call and associated to the contact. At step 210, the electronic device sets the priority level to the communication note. In an embodiment, the priority level can be indicated by the indicia. In an example, the communication note with the Low priority level can be indicated by a green color (i.e., indicia). In another example, the communication note with the Medium priority level can be indicated by the blue color (i.e., indicia). In another example, the communication note with the High priority level can be indicated with the red color (i.e., indicia). At step 212, the electronic device saves the communication note associated with the priority level in the communication note inventory 108.

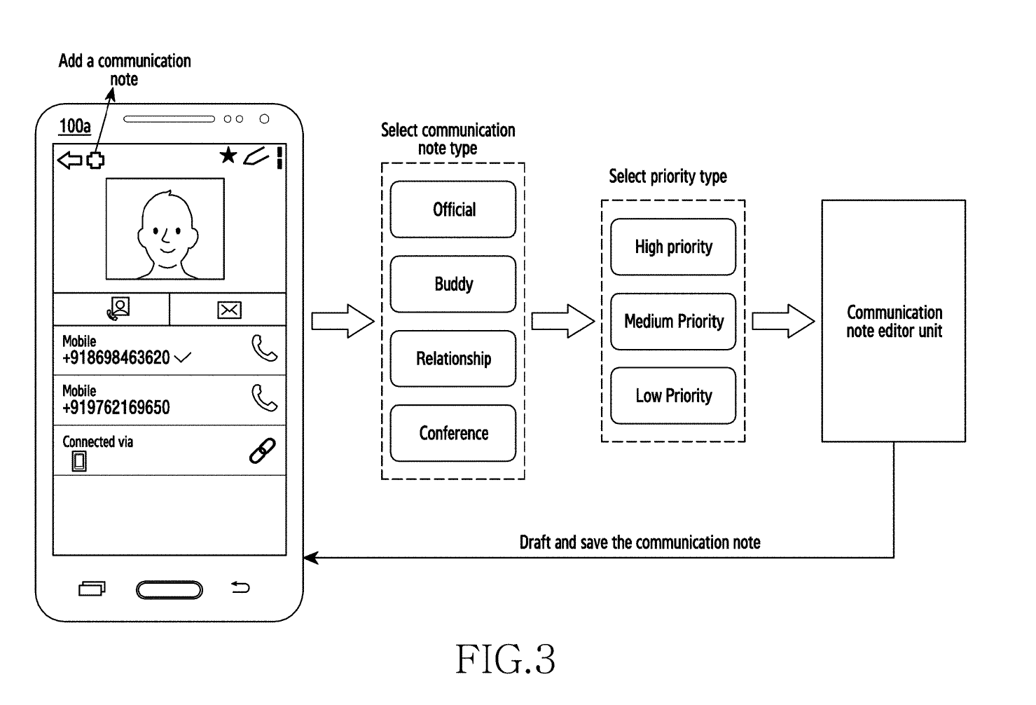

At step 214, the electronic device determines what step is performed. If it is determined that an “Incoming call” occurs, then step 600 is performed. If it is determined that “No call” occurs, processes drafting the communication note for a contact prior to the call are stopped at step 218. If it is determined that “Incoming call” or “Outgoing call” occur, the drafted communication notes are sent to the contact at step 216. After the step 216, the processes drafting the communication note for a contact prior to the call are stopped at step 218. The example illustration for creating the communication note is explained in conjunction with FIG. 3.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

FIG. 3 shows an example illustration in which the communication note is created and assigned to the contact stored in the phonebook prior to the call, according to an embodiment of the present disclosure. As shown in the FIG. 3, initially, the contact to which the communication note has to be created is selected from the phonebook 104. The selected contact is displayed on the screen of the electronic device 100a as shown in the FIG. 3. The user then performs the gesture event to add the communication note for the contact. In an example, the gesture event can be a Touch gesture, a Hover gesture, a Slide gesture, or the like.

Further, the user selects the type of category for the communication note. After selecting the type of category, the user sets the priority level to the communication note as shown in the FIG. 3. Thus, the communication note is pre-drafted and stored in the communication note inventory 108. Below described are some of the examples of the communication notes drafted for the contact.

Official communication note: Consider a scenario where the user is on leave and the user is “On Call” for a project work issues. In this case, the user expects to receive the incoming call from his/her lead on technical queries related to the project. Before receiving the incoming call, the user can draft the communication note (i.e., official communication note in blue color) with the lead's contact number for a smooth conversation so that the user should not forget the discussion points (i.e., data items) to be discussed with the lead. The communication note encloses the important points to be discussed when the user is in call with the lead. The important points that can be drafted are described below:
h. Pending issues.
i. Issue details.
j. Discussing about leave.
k. Resuming to office.

The user sets the display priority level for the communication note. When the call is received, the drafted communication note is dynamically invoked based on the priority level of the communication note. In case if the call is disconnected due to any reason within the priority time, then remaining important points which are not discussed during the call are sent to the lead through the message in order to complete the conversation.

Buddy communication note: Consider a scenario where an outing trip is planned by the user with 3 friends. In this case, the user need to make the outgoing call to 3 friends reminding on the important things to be brought on the outing day, means of transport, and route which needs to be followed. The user prior to making the outgoing call, the communication note (i.e., buddy communication note in the yellow color) which reminds the user of the important points to be discussed during the call is drafted. The important points that can be drafted are described below:
l. Confirming who all are coming.
m. Route which needs to be followed to reach destination.
n. Reminding on stuff that needs to be brought.

Relationship communication note: Consider a scenario in which there is a celebration of a birthday function of the user child and the user intends to invite relatives. In this case, the user can draft the communication note (i.e., relationship communication note in the purple color) with the contacts prior to making the outgoing call. The important points that can be drafted are described below:
o. Venue of the birthday function.
p. Timings.
q. Date, or the like.

Conference communication note: Consider a scenario where the user intends to make a conference call with a group of people. In this case, the user creates the communication note where the information is required to convey to the group of people.

In an embodiment, consider a scenario where the user receives most of the calls on address changes, contact changes, bank staff ask for 2 last transactions, so this information can be drafted with the customer care number. There are also calls being received from the operator services which has a questionnaire which needs to be drafted along with the call. Likewise many scenarios can be possible in relations, office work, friendship, or the like.

In an embodiment, the communication notes can be associated with the priority level. The priority level associated with the communication note helps the user to have complete conversation over minute's calls using the prioritized communication notes. Further, the communication notes are prioritized and the priority level decides the visibility of the communication notes. The conversation duration of the call can be decided based on the priority level being set. The priorities or urgencies can be High, Medium, or Low. In an example, in case of a High urgent call, the user receives the call and the user has drafted the communication note with the high urgency with the contact. For urgent call discussion, the visibility of the communication note is 5 sec say and conversation duration limit is 1 minute say. So if the call is not answered within 5 seconds, the communication note is expanded on the screen of the electronic device 100a. And if the call duration is less than 1 minute, then the communication note is sent to the contact and vice-versa. Moreover, sending of the communication note is calculation based on duration of the missed call, when the other side is not answering the call.

In an embodiment, the transparent communication note computes the priority level of the communication note attached against any number based on the number of missed calls and length of the missed call durations received on the same number. After computing the priority level of the communication note, if it exceeds the predefined limit of urgency then the communication notes are shared to the user implicitly. In an embodiment, the communication notes can be shared with the contact helping the user and the contact to get in sync and have the call agenda in-hand ready with both the parties of the call.

In an embodiment, the opacity of the communication note can be varied with the call duration. As the call duration increases and conversation goes on, the opacity of the communication note starts decreasing, after certain time completes then the communication note becomes transparent and the text is disappeared from the calling screen.

In an embodiment, the communication notes have different categories that are described by the color of the opened communication notes. The communication notes are of the official, personal, buddy, or relationship. In an embodiment, the size of the communication note varies while the content is discarded from the communication note during the call.

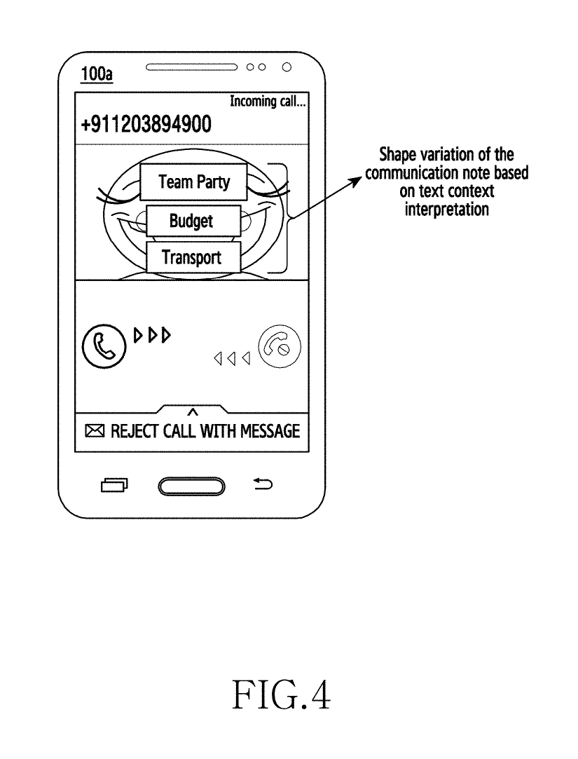

FIG. 4 shows an example illustration in which the shape of the communication note is varied based on the type of data items, according to an embodiment of the present disclosure. As shown in the FIG. 4, the shape of the communication note can be decided by a Text Context Interpreter (TCN) based on the data item. The TCN is an interpreter which interprets the context of the note based on the content type, content tone, content length and content language. The TCN can decide the shape and/or image of the communication note. At step 401, the shape variation of the communication note is determined based on text context interpretation. The TCN can use pre-existing tools to interpret the context of the text and decide the background image of the communication note. In an example, if the calling party has three sticky notes for a called party, these would appear as per the shape and size of the communication note during call. For example, a smiley image or a corporate view image can be decided as the communication note background based on the context of the content.

In an embodiment, the user can scan a real world communication note shapes along with the contents and other object shapes in the software form when drafting the communication notes. This provides a wide scope for designing the communication note shapes.

In an embodiment, the transparent communication note system uses the existing color scanning methods to scan the color of any software or real time objects that can represent the type or mood of the communication notes and same is applied to a newly created communication note background.

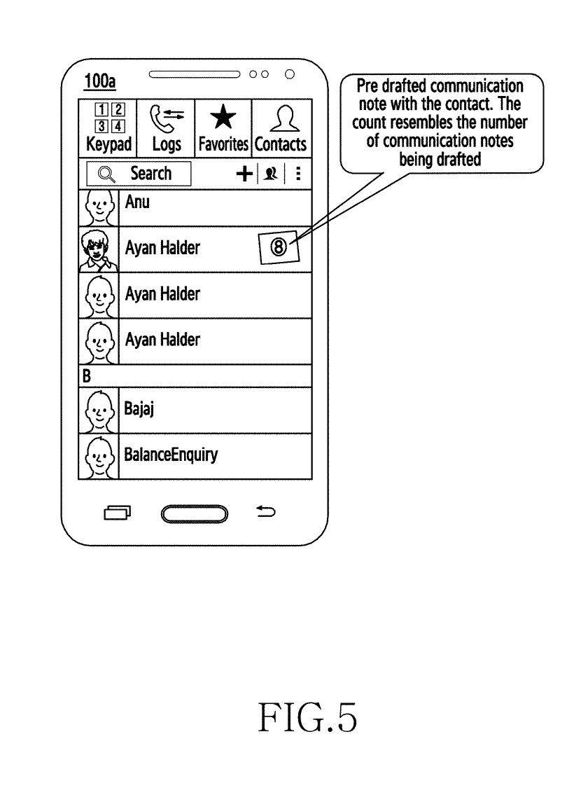

FIG. 5 shows an example illustration of a contact screen showing the contacts and a symbol in the form of the communication note image, according to an embodiment of the present disclosure. As shown in the FIG. 5, the communication note image indicates that the communication note has been drafted along with the contact “Ayan Halder.” Further, the count over the image resembles the number of communication notes being drafted prior to the incoming call or the outgoing call at step 501.

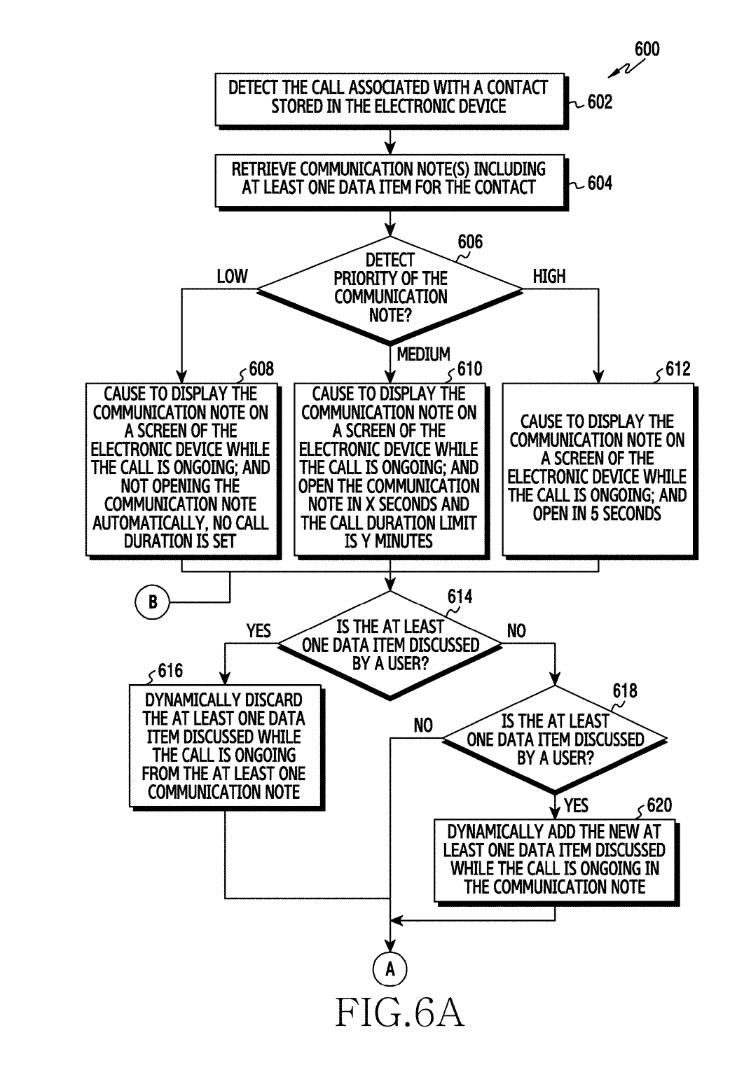

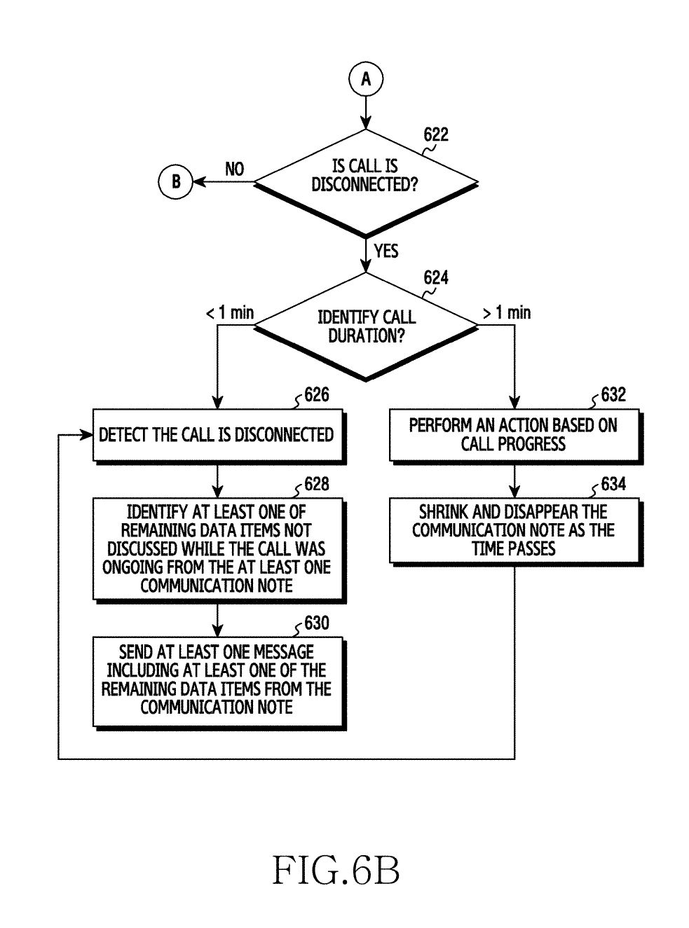

FIGS. 6A and 6B are a flow diagram 600 illustrating a method for managing the communication note in the electronic device 100a, according to an embodiment of the present disclosure. FIGS. 6A and 6B exemplify a method for operating the electronic device 110a.

Referring FIG. 6A and FIG. 6B, at step 602, the electronic device (i.e., the communication note manager 106 or the processor 110) detects the call associated with the contact stored in the electronic device 100a. In an embodiment, the parameter of the communication note is dynamically defined based on the type of the data item or the amount of the data item, where the parameter includes the position, the size, the shape, the color, the category, the opacity level, the background, or combination of same.

At step 604, the electronic device retrieves the communication note including the data item for the contact from the communication note inventory 108. In an embodiment, the communication note is automatically retrieved from the communication note inventory 108 hosted locally. In another embodiment, the communication note is automatically retrieved from the communication note inventory hosted remotely.

At step 606, if it is determined that the priority level of the communication note is low, then at step 608, the electronic device causes to display the communication note on the screen of the electronic device 100a while the call is ongoing; and not opening the communication note automatically, no call duration is set and step 614 is performed. At step 606, if it is determined that the priority level of the communication note is medium, then at step 610, the electronic device causes to display the communication note on the screen of the electronic device 100a while the call is ongoing; and open the communication note in X seconds (for example: 10 seconds) and the call duration limit is Y minutes (for example: 3 minutes) and step 614 is performed.

At step 606, if it is determined that the priority level of the communication note is high, then at step 612, the electronic device causes to display the communication note on the screen of the electronic device 100a while the call is ongoing; and the communication note is opened in M seconds (for example: 5 seconds) and step 614 is performed. The communication note is associated with the indicia indicating the priority level. Further, the priority level is dynamically defined based on the amount of data items inputted by the user, the type of data items, or combination of same. In an embodiment, the data item in the communication note is displayed based on the display event while the call is ongoing, where the display event is dynamically defined based on the glide event, the proximity event, the time event, the priority level, or combination of same. In an embodiment, the date item in the communication note is displayed based on the gesture event while the call is ongoing, where the gesture event is the glide event or the proximity event.

At step 614, if it is determined that the data item is discussed by the user of the electronic device 100a while the call is ongoing then, at step 616, the electronic device dynamically discards the data item discussed while the call is ongoing from the communication note and step 622 is performed. If the at least one data item is detected on the call, the electronic device discards the at least one data item from the at least one communication note based on the contents of the conversation while the call is ongoing. The electronic device changes the communication note based on contents of conversation on the call At step 614, if it is determined that the data item is not discussed by the user of the electronic device 100a while the call is ongoing then, at step 618, the electronic device detects whether a new data item is discussed by the user of the electronic device 100a while the call is ongoing.

At step 618, if it is determined that the new data item is discussed by the user then, at step 620, the electronic device dynamically adds the new data item discussed while the call is ongoing in the communication note. At step 618, if it is determined that the new data item is not discussed by the user then step 622 is performed. If at least one new data item is detected on the call, the electronic device adds the at least one new data item to the at least one communication note based on the contents of the conversation while the call is ongoing. The electronic device changes the communication note based on contents of conversation on the call.

At step 622, if it is determined that the call is not disconnected, then step 614 is performed. At step 622, if it is determined that the call is disconnected, then at step 624, the electronic device identifies the duration of the call. At step 624, if it is determined that the call duration is less than “A” minutes (i.e., 1 minute), then at step 626, the electronic device detects the call is disconnected. At step 628, the electronic device identifies the remaining data items not discussed while the call was ongoing from the communication note. At step 630, the electronic device sends at least one message including the remaining data items from the communication note. In an example, if the duration of the call is less than 1 minute, the high priority note would be sent to the other party else. Further, the communication notes shared and left over points in the communication note would be shared after the call.

At step 624, if it is determined that the call duration is greater than “A” minute (i.e., 1 minute), then at step 632, the electronic device performs an action based on call progress:

Call Progress: 1 Minute 50 Seconds
r. Color and transparency of the communication mote fades away.
s. Discussion points are discarded based on voice recognition and note shrinking.

Call Progress: 2 Minute 30 Seconds
t. Color and transparency of the communication mote fades away.
u. Discussion points are discarded based on voice recognition and note shrinking.

At step 634, the electronic device shrinks and disappears the communication note as the time passes and step 626 is performed. With the time passes, the communication note transparency fades and shrinks based on the discussed points.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

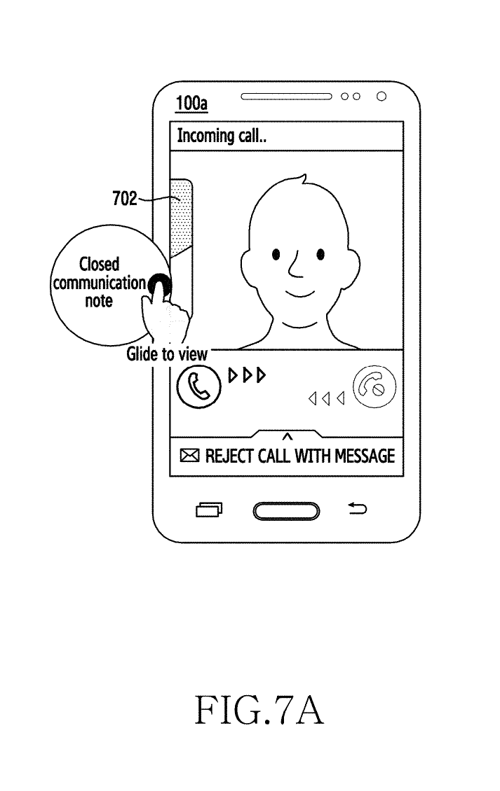

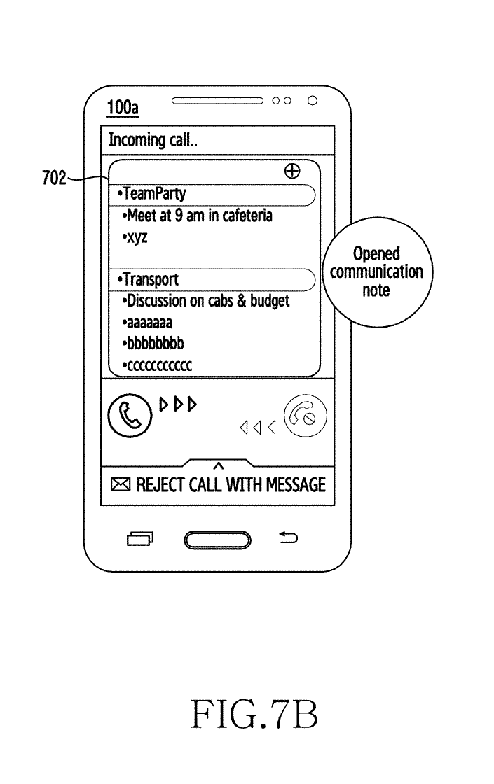

FIGS. 7A and 7B shows an example illustration in which the communication note is displayed on the screen when the user receives the incoming call, according to an embodiment of the present disclosure. Consider a scenario where the user receives the incoming call from the contact stored in the electronic device 100a. The communication note manager 106 detects the incoming call from the contact. After detecting the incoming call, the communication note manager 106 retrieves the communication note including the data item for the contact from the communication note inventory 108.

Further, the communication note manager 106 displays the closed view of the communication note 702 (i.e., closed communication note) on the screen while the incoming call is ongoing as shown in the FIG. 7A. The communication note 702 is associated with the indicia indicating the priority level. If the user performs the glide event on the closed communication note 702, then the communication note 702 is opened to show the points to be discussed while the incoming call is ongoing as shown in the FIG. 7B.

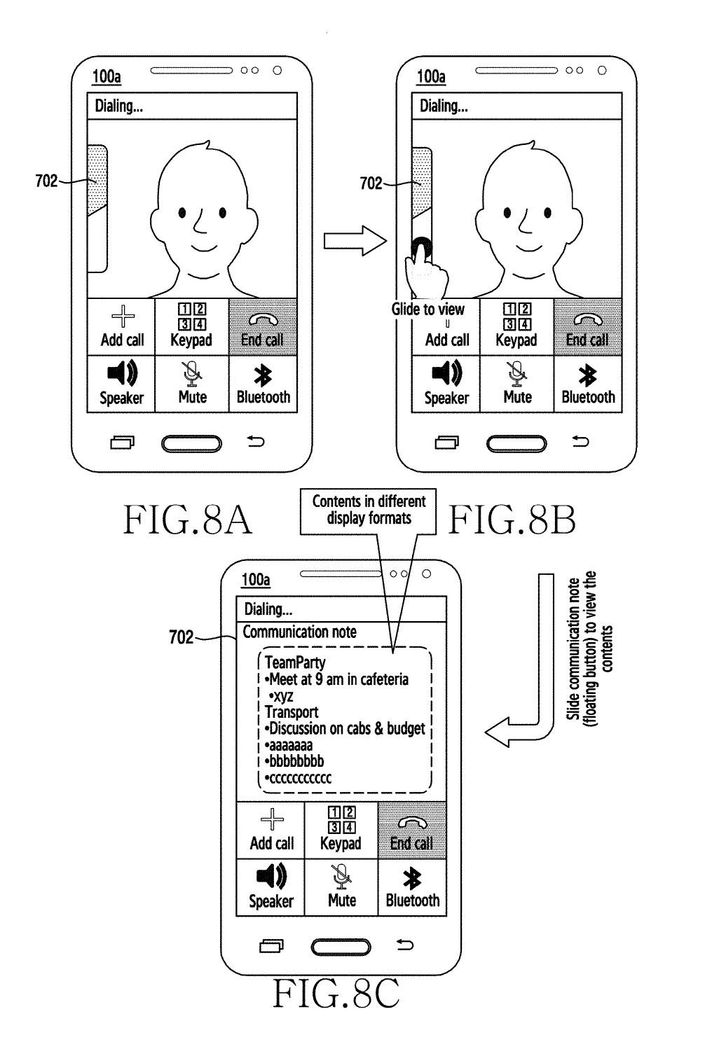

FIGS. 8A to 8C show an example illustration in which the communication note 702 is displayed on the screen of the electronic device 100a when the user makes the outgoing call, according to an embodiment of the present disclosure. Consider a scenario where the user makes the outgoing call to the contact stored in the electronic device 100a. The communication note manager 106 detects the outgoing call to the contact. After detecting the outgoing call, the communication note manager 106 retrieves the communication note 702 including the data item for the contact from the communication note inventory 108.

Further, the communication note manager 106 displays the closed view of the communication note 702 (i.e., closed communication note in a form of a floating button) on the screen while the outgoing call is ongoing as shown in the FIG. 8A. The communication note 702 is associated with the indicia indicating the priority level. The user performs the glide gesture on the closed communication note 702 as shown in the FIG. 8B. After detecting the glide gesture, the communication note manager 106 opens the communication note 702 to show the points to be discussed while the outgoing call is ongoing as shown in the FIG. 8C. The contents in the communication note 702 are displayed in different formats.

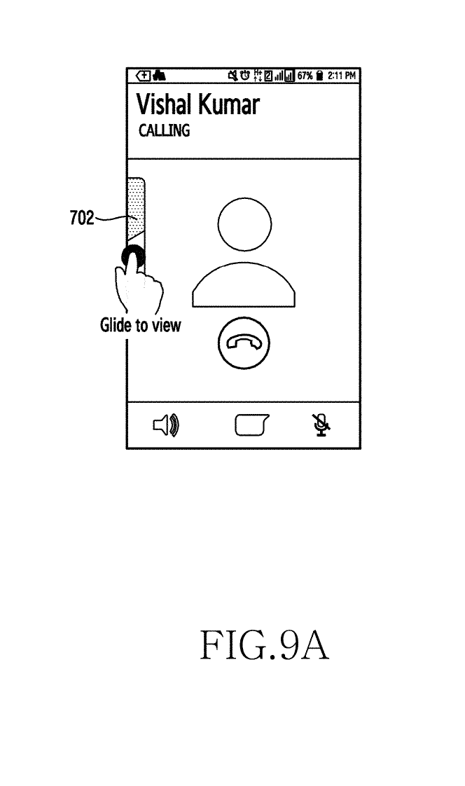

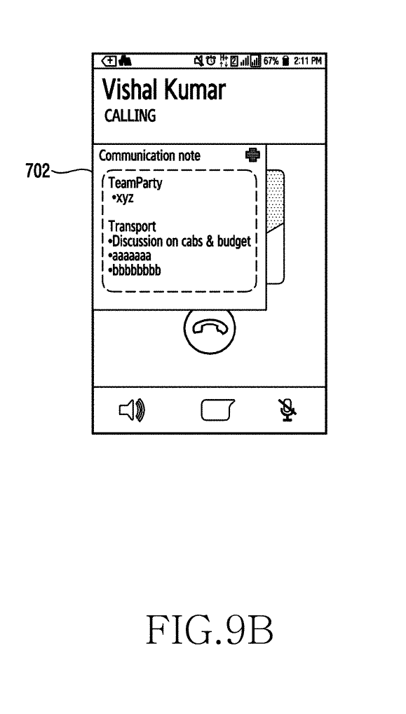

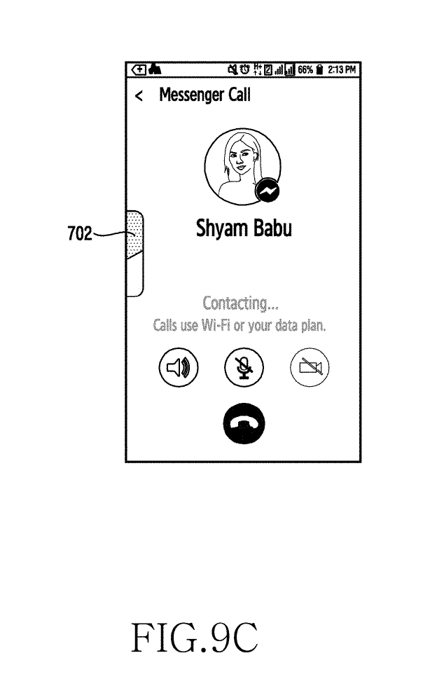

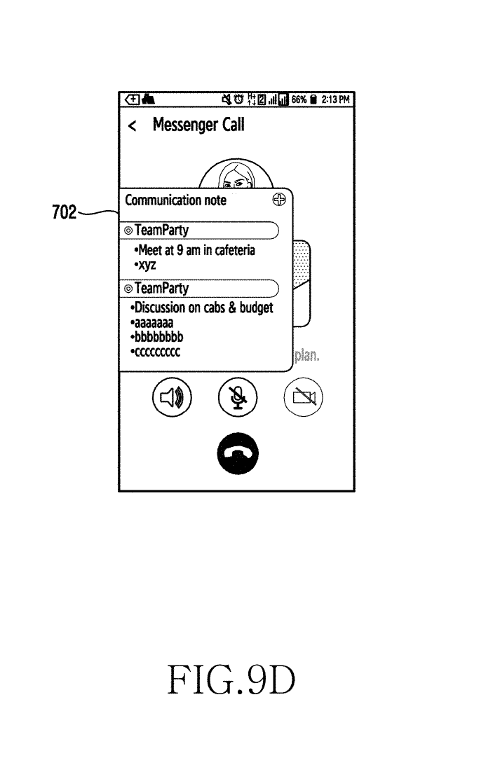

FIGS. 9A and 9B show an example illustration in which the communication note 702 is displayed on the screen when the user makes the outgoing call through messaging application (For example: WhatsApp application), according to an embodiment of the present disclosure. Consider a scenario where the user makes the outgoing call through the WhatsApp application to the contact stored in the electronic device 100a. The communication note manager 106 detects the WhatsApp outgoing call to the contact. After detecting the outgoing call, the communication note manager 106 retrieves the communication note 702 including the data item for the contact from the communication note inventory 108.

Further, the communication note manager 106 displays the closed view of the communication note 702 (i.e., closed communication note) on the screen while the outgoing call is ongoing as shown in the FIG. 9A. The communication note 702 is associated with the indicia indicating the priority level. If the user performs the glide gesture on the closed communication note 702, then the communication note 702 is opened to display the points to be discussed while the outgoing call is ongoing as shown in the FIG. 9B.

FIGS. 9C and 9D show an example illustration in which the communication note 702 is displayed on the screen when the user makes the outgoing call through messaging application (For example: Facebook application), according to an embodiment of the present disclosure. Consider a scenario where the user makes the outgoing call through the Facebook application to the contact stored in the electronic device 100a. The communication note manager 106 detects the Facebook outgoing call to the contact. After detecting the outgoing call, the communication note manager 106 retrieves the communication note 702 including the data item for the contact from the communication note inventory 108.

Further, the communication note manager 106 displays the closed view of the communication note 702 (i.e., closed communication note) on the screen while the outgoing call is ongoing as shown in the FIG. 9C. The communication note 702 is associated with the indicia indicating the priority level. If the user performs the glide gesture on the closed communication note 702, then the communication note 702 is opened to display the points to be discussed while the outgoing call is ongoing as shown in the FIG. 9D.

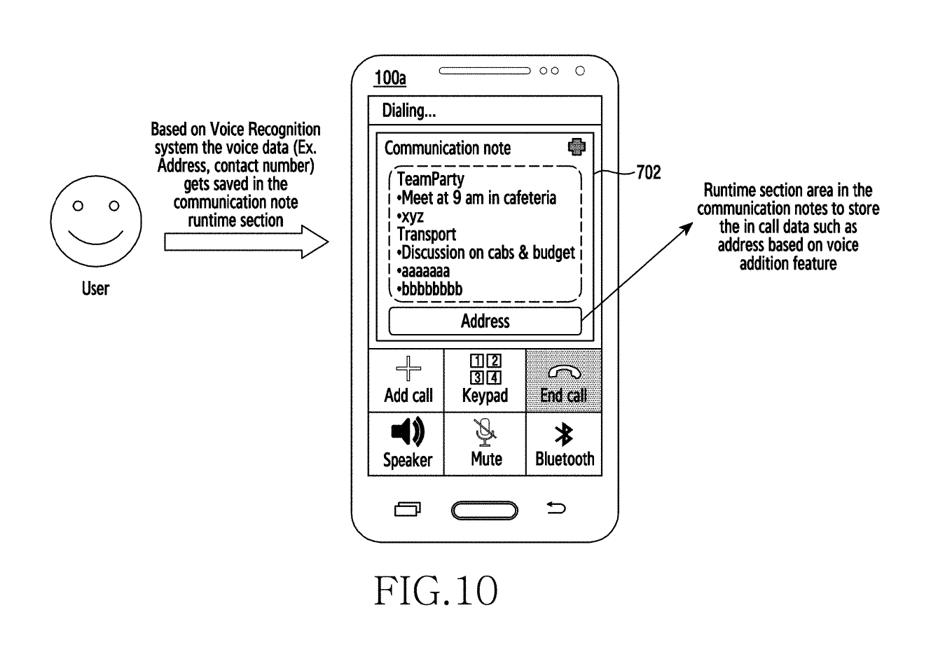

FIG. 10 shows an example illustration in which the new data item discussed by the user 1002 is added into the communication note 702 while the call is ongoing, according to an embodiment of the present disclosure. Consider a scenario where the user 1002 makes the outgoing call to the contact or receives the incoming call from the contact. While the call is ongoing, the communication note manager 106 detects the new data item (such as address and contact number) discussed by the user using the voice processor 114. Further, the communication note manager 106 dynamically adds the new data item into the communication note 702. As shown in the FIG. 10, by using the voice processor 114, the voice data (for example: address and contact number) is saved into the communication note 702 runtime section. The runtime section area in the communication note 702 is shown in the FIG. 10.

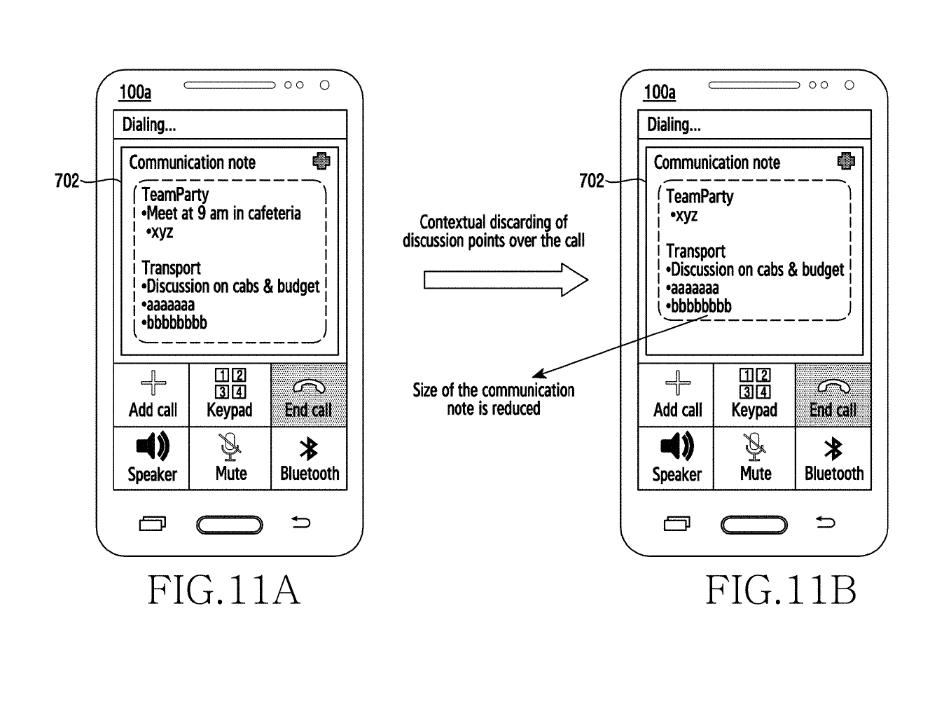

FIGS. 11A and 11B show an example illustration in which the content is dynamically discarded from the communication note 702 when the user discusses the content while the call is ongoing, according to an embodiment of the present disclosure. As shown in the FIG. 11A, the communication 702 note is displayed on the screen. The communication note manager 106 detects the data item discussed by the user of the electronic device 100a while the call is ongoing; and dynamically discards the data item discussed as shown in the FIG. 11B. If the data item is discarded, the size of the communication note 702 is reduced as shown in the FIG. 11B. If all the data items are discussed by the user, then the communication note 702 is completely vanished else the remaining data items are shared with the contact through the message. In an example, contextual discarding of the data items over the call is performed.

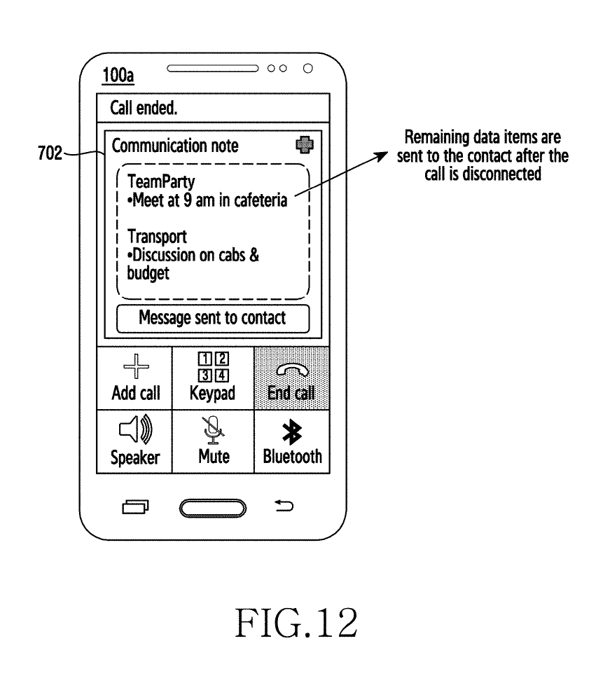

FIG. 12 shows an example illustration in which the remaining data items are sent through the message when the call is disconnected, according to an embodiment of the present disclosure. The communication note manager 106 detects whether the call is disconnected. If the call is disconnected, the communication note manager 106 identifies the remaining data items not discussed while the call was ongoing from the communication note 702. Further, the communication note manager 106 sends the remaining data items to the contact through the message as shown in the FIG. 12. The communication note manager 106 transmit at least one message comprising the at least one remaining data item to at least one electronic device associated with the contact information.

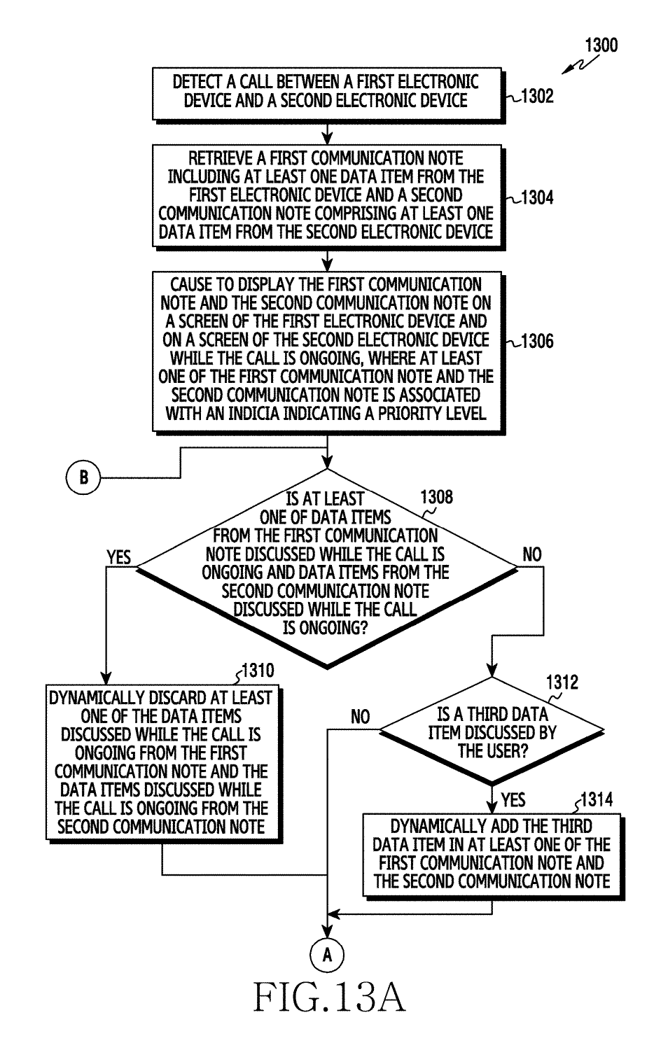

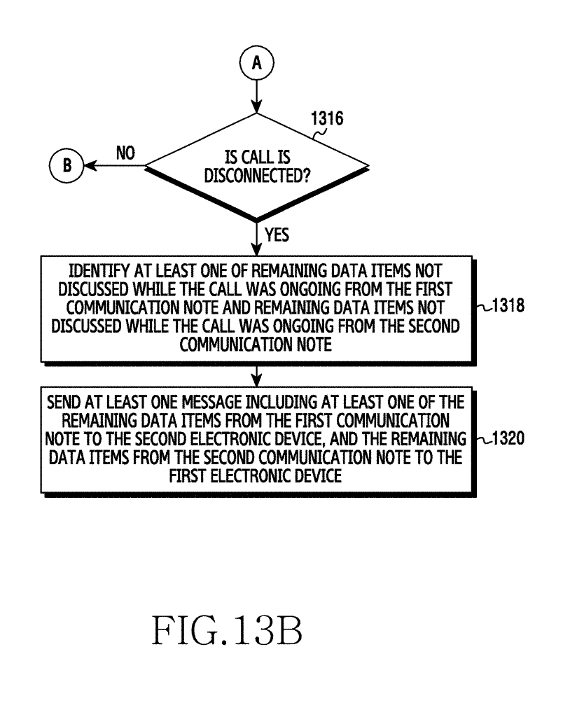

FIGS. 13A and 13B are a flow diagram 1300 illustrating a method for managing the communication note 702, according to an embodiment of the present disclosure. FIGS. 13A and 13B exemplify a method for operating the electronic device 110a.

Referring FIG. 13A and FIG. 13B, at step 1302, the electronic device (i.e., the communication note manager 106 or the processor 110) detects the call between the first electronic device 100a and the second electronic device 100b. At step 1304, the electronic device retrieves the first communication note including the data item from the first electronic device 100a and the second communication note including the data item from the second electronic device 100b.

At step 1306, the electronic device causes to display the first communication note and the second communication note on the screen of the first electronic device 100a and on the screen of the second electronic device 100b while the call is ongoing, where at least one of the first communication note and the second communication note is associated with the indicia indicating the priority level.

At step 1308, if it is determined that at least one of the data items from the first communication note discussed while the call is ongoing and the data items from the second communication note discussed while the call is ongoing then, at step 1310, the electronic device dynamically discards at least one of the data items discussed while the call is ongoing from the first communication note and the data items discussed while the call is ongoing from the second communication note.

At step 1308, if it is determined that at least one of the data items from the first communication note not discussed while the call is ongoing and the data items from the second communication note not discussed while the call is ongoing then, at step 1312, the electronic device detects the third data item discussed by the user. At step 1312, if it is determined that the third data item is not detected, then step 1316 is performed as described below. At step 1312, if it is determined that the third data item is detected, then at step 1314, the electronic device dynamically adds the third data item in at least one of the first communication note and the second communication note.

At step 1316, if it is determined that the call is not disconnected, then step 1308 is performed as described above. At step 1316, if it is determined that the call is disconnected, then at step 1318, the electronic device identifies at least one of the remaining data items not discussed while the call was ongoing from the first communication note and the remaining data items not discussed while the call was ongoing from the second communication note. At step 1320, the electronic device sends the message including at least one of the remaining data items from the first communication note to the second electronic device 100b, and the remaining data items from the second communication note to the first electronic device 100a.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

FIG. 14 shows an example illustration in which the first communication note and the second communication note are displayed on the screen of the first electronic device 100a, according to an embodiment of the present disclosure. Consider a scenario where the user of the first electronic device 100a is in call with the contact stored in the first electronic device 100a. The contact is associated with the second electronic device 100b.

As shown in the FIG. 14, if the user and the contact both have the communication notes (i.e., the first communication note and the second communication note) against each other, then the communication note manager 106 displays the first communication note retrieved from the first electronic device 100a and the second communication note retrieved from the second electronic device 100b on the screen of the first electronic device 100a. Further, the common discussion points are interlinked and are discarded from the first communication note and the second communication note based on the voice context at the same time. The arrow marked points are discarded based on the voice context from the first communication note and the second communication note. As shown in the FIG. 14, the user can glide the communication note floating button to view the second communication note completely.

In an embodiment, the voice processor 114 can identify the voice content using existing speech recognition system over the call and compare with the stored text content on the communication note. The content is discarded from the communication notes on the basis of maximum words of the discussion point being used. This can eventually discard the complete communication note that is already being discussed over call.

In an embodiment, if the user is speaking then the first communication note is displayed on the screen of the first electronic device 100a and the second communication note is hidden. Further, if the user is listening then the second communication note is displayed on the screen of the first electronic device 100a and the first communication note is hidden. Similarly, the first communication note and the second communication note can be displayed on the screen of the second electronic device 100b at the same time thus, making the communication more effective by synching both the sides.

In an embodiment, any person on any side of the call requires conveying some address or any other information, the person who speaks up the information gets stored into the runtime communication note section of the communication note of the other person. Also, the person can write into the communication note of other person in a dual mode display of the communication note so that it can be seen by the other user. The person can edit the at least one communication note on the first electronic device and on the second electronic device while the call is ongoing.

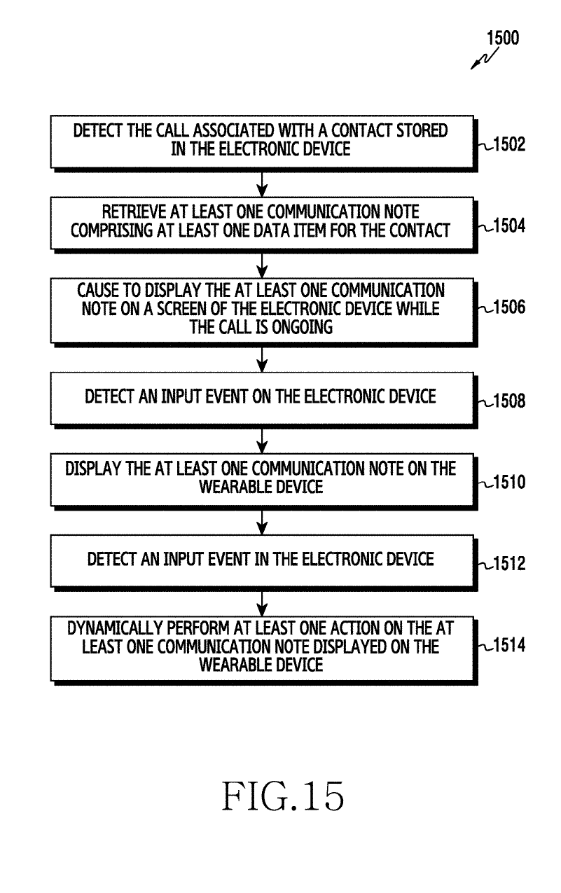

FIG. 15 is a flow diagram 1500 illustrating a method for dynamically performing an action on the communication note 702 displayed on the wearable device 100b, according to an embodiment of the present disclosure. FIG. 15 exemplifies a method for operating the electronic device 110a.

Referring FIG. 15, at step 1502, the electronic device (i.e., the communication note manager 106 or the processor 110) detects the call associated with the contact stored in the electronic device 100a.

At step 1504, the electronic device retrieves the communication note 702 including the data item for the contact. At step 1706, the electronic device causes to display the communication note 702 on the screen of the electronic device 100a while the call is ongoing.

At step 1508, the electronic device detects the input event on the electronic device 100a. At step 1510, the electronic device displays the communication note 702 on the wearable device 100b. At step 1512, the electronic device detects the input event in the electronic device 100a. The electronic device transmit the communication note to the wearable device. At step 1514, the electronic device dynamically performs the action on the communication note 702 displayed on the wearable device 100b.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

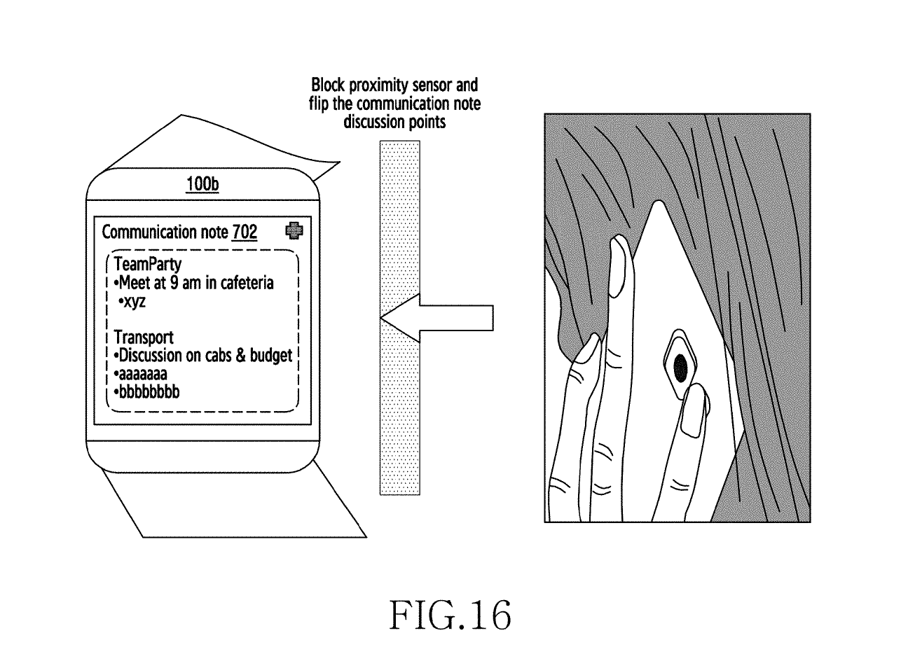

FIG. 16 shows an example illustration in which the discussion points in the communication note 702 displayed on the wearable device 100b when the user 1602 blocks the proximity sensor of the electronic device 100a, according to an embodiment of the present disclosure. The user 1602 can render the communication note 702 on the smart watch (i.e., wearable device 100b) and which interacts with the electronic device 100a via the proximity sensor.

During the conversation on call, the user 1602 views the communication note 702 displayed on the smart watch and the discussion points flips when the proximity sensor is blocked by the user for a longer period as shown in the FIG. 16. In an embodiment, the discussion points of the communication note 702 keeps changing when the proximity sensor is blocked for the longer duration. In another embodiment, the user 1602 blocks the proximity sensor once in order to change the single discussion point. In another embodiment, the user 1602 blocks the proximity sensor twice (i.e., double blocking) in order to change the previous discussion point.

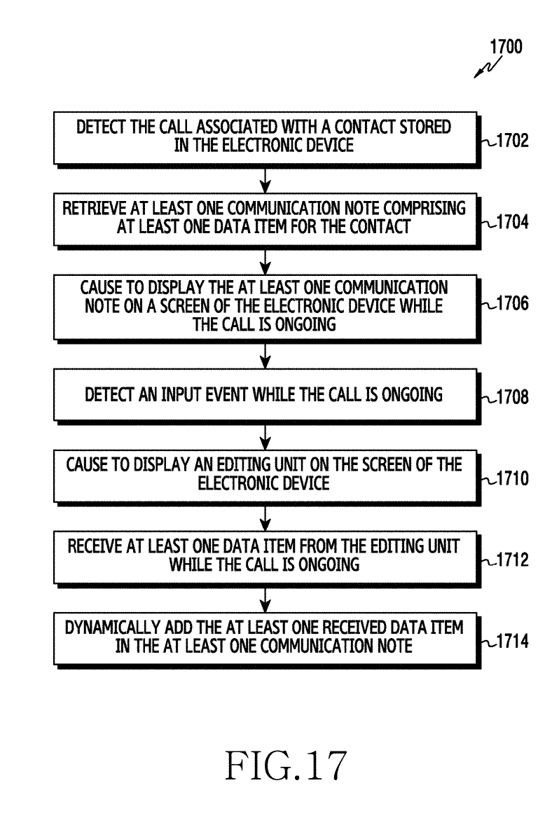

FIG. 17 is a flow diagram 1700 illustrating a method for dynamically adding the received data item in the communication note 702, according to an embodiment of the present disclosure. FIG. 17 exemplifies a method for operating the electronic device 110a

Referring FIG. 17, at step 1702, the electronic device (i.e., the communication note manager 106 or the processor 110) detects the call associated with the contact stored in the electronic device 100a. At step 1704, the electronic device retrieves the communication note 702 including the data item for the contact. At step 1706, the electronic device causes to display the communication note 702 on the screen on the electronic device 100a while the call is ongoing. At step 1708, the electronic device detects the input event while the call is ongoing.

At step 1710, the electronic device causes to display an editing unit on the screen of the electronic device 100a. Editing window may have same meaning as the editing unit. At step 1712, the electronic device receives the data item from the editing unit while the call is ongoing. At step 1714, the electronic device includes dynamically adds the received data item in the communication note 702.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the invention.

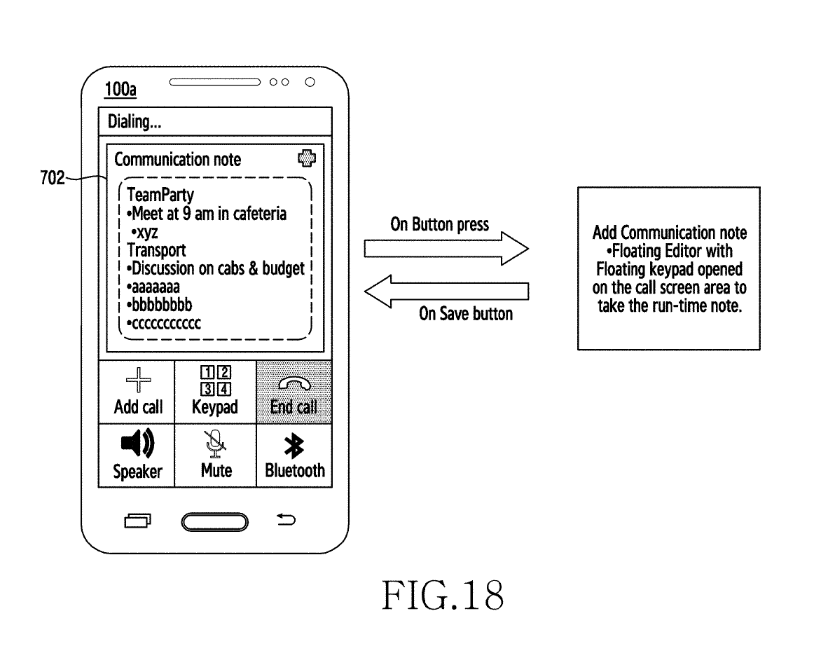

FIG. 18 shows an example illustrating in which the communication note 702 is edited while the call is ongoing, according to an embodiment of the present disclosure. The user performs the input event while the call is ongoing. After detecting the input event, the editing unit with a keypad is displayed on the screen of the electronic device 100a to take runtime points as shown in the FIG. 18. The contents such as the address, the contact number, and some important information being spoken by the contact are entered into the communication note 702. In an embodiment, the editing unit with the keypad opened on the call screen to take the run-time notes.

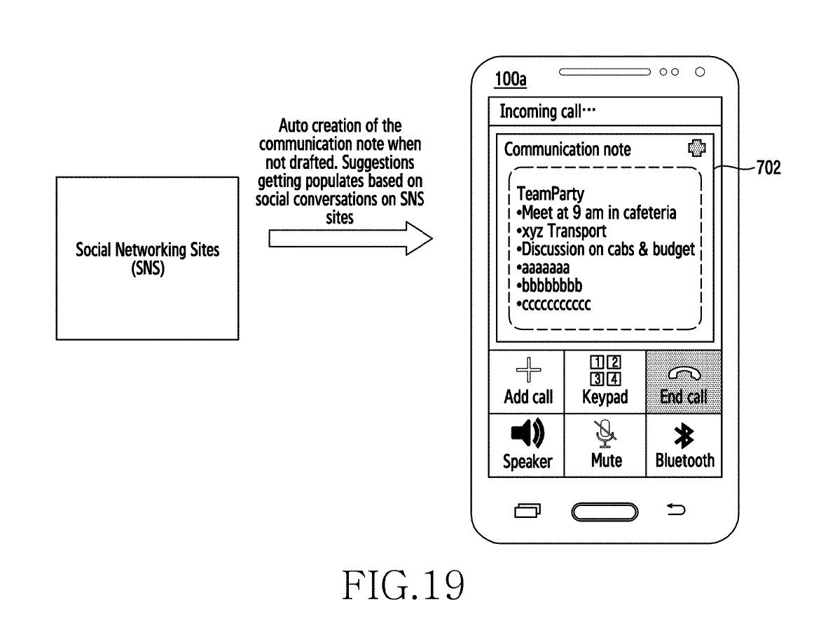

FIG. 19 shows an example illustration in which SNS based suggestions are displayed on the communication note 702 when the communication note 702 for the contact is not drafted, according to an embodiment as herein. Consider a scenario where the communication note 702 is not pre-drafted for the contact stored in the electronic device 100a. When the communication note 702 is not drafted for the contact, the communication note manager 106 gathers or performs data mining from the SNS (such as Facebook, WhatsApp, Twitter, etc.) of the old communication notes or fetches the discussion agenda and suggests to the user displaying the content on the screen of the electronic device 100a for discussion.

In an embodiment, the SNS based suggestions can be used for non-drafted communication note contents composition using the data mining on the old communication notes database or Facebook which provides the user with the discussion agenda based on the past relevant discussion.

In an embodiment, consider a scenario when the user received an unexpected call from the contact stored in the electronic device 100a when the communication note 702 for the contact is not drafted. In this case, the discussion agenda is fetched from the past communication notes database or from the SNS web sites. For example, the current discussion agenda can be suggested based on the SNS.

In an embodiment, the communication note 702 is opened while the call is ongoing based on the priority level or the user performing the gesture event. Further, the communication note 702 can be opened using the proximity sensor. Whenever the electronic device 100a is moved away from the ear of the user, the proximity sensor detects the proximity and the communication note 702 is opened.

In an embodiment, consider a scenario when there is urgency for communication over some important points and the contact is unable to pick up the call. In this case, the priority level of the communication note 702 is computed based on the missed call numbers and duration of the missed the call. If it is computed as the High priority level communication note then it will be dispatched automatically to the contact through any content sharing method.

The communication note 702 setting at the electronic device 100a are described below:
v. Priority level settings: The user sets the priority level of the communication notes being drafted prior to the call.
w. Category selection: The user can select the category of the communication notes. For example, the communication note can be the personal, official, relationship, buddy, or the like.
x. Deletion Settings: The user can also set the settings such as when to delete the communication note being drafted, after the call has been made. The deletion can be Auto deletion after the call has been received or made, or say 1 day after the call has been received.
y. Communication note message settings: The user can set the setting (ON/OFF) for whether one has to send the remaining data items through the message after the call is disconnected.

The communication note 702 options at the electronic device 100a are described below are described below:
z. Clip Option: Clip Option is to draft the communication note 702 and stick (i.e., associate) it with the contact.
aa. Save or Stick Option: Save option is to save or stick the communication note 702 being drafted with the contact.
bb. Single or Dual Communication Note Display Option: This option will control the display on the call screen. Dual is for both sides communication note's display.

The communication note 702 control options at the electronic device 100a are described below are described below:
cc. Drafting the communication note 702 with the contact: The user has to draft the communication note 702 containing the discussion points for effective conversation over the call, prior to the call.
dd. Gliding the communication note floating button: The user can glide the communication note floating button to view the contents of the drafted communication note.
ee. Modifying the settings mentioned above: The user has the control to modify any of the settings like of priority, category, and deletion.

Unlike conventional systems and methods, the communication note 702 can be pre-drafted prior to the incoming call which encompasses the thoughts lingering in the mind of the user and display during the call. Further, the communication note 702 gets updated based on the runtime voice discussion. The communication note duality feature makes it more effective since both the parties gets synch up with each other.

Through the proposed mechanism, effective and summarized discussion over the call with dynamic contextual content update based on the voice.

Further, the user is not taking the call notes during the call; neither the user is making an entry in the address book. In the proposed mechanism, the communication note is pre-drafted as and when the thoughts are lingering in the mind of the user. The communication note is drafted or updated and has the priority level being set with the color fading, transparency, shrinking concepts based on the voice context.

In an embodiment, the computing environment comprises at least one processing unit that is equipped with a control unit and an Arithmetic Logic Unit (ALU), a memory, a storage unit, plurality of networking devices and a plurality Input output (I/O) devices. The processing unit is responsible for processing the instructions of the technique. The processing unit receives commands from the control unit in order to perform its processing. Further, any logical and arithmetic operations involved in the execution of the instructions are computed with the help of the ALU.

The overall computing environment can be composed of multiple homogeneous and/or heterogeneous cores, multiple CPUs of different kinds, special media and other accelerators. The processing unit is responsible for processing the instructions of the technique. Further, the plurality of processing units may be located on a single chip or over multiple chips.

The technique comprising of instructions and codes required for the implementation are stored in either the memory unit or the storage or both. At the time of execution, the instructions may be fetched from the corresponding memory or storage, and executed by the processing unit.

In case of any hardware implementations various networking devices or external I/O devices may be connected to the computing environment to support the implementation through the networking unit and the I/O device unit.

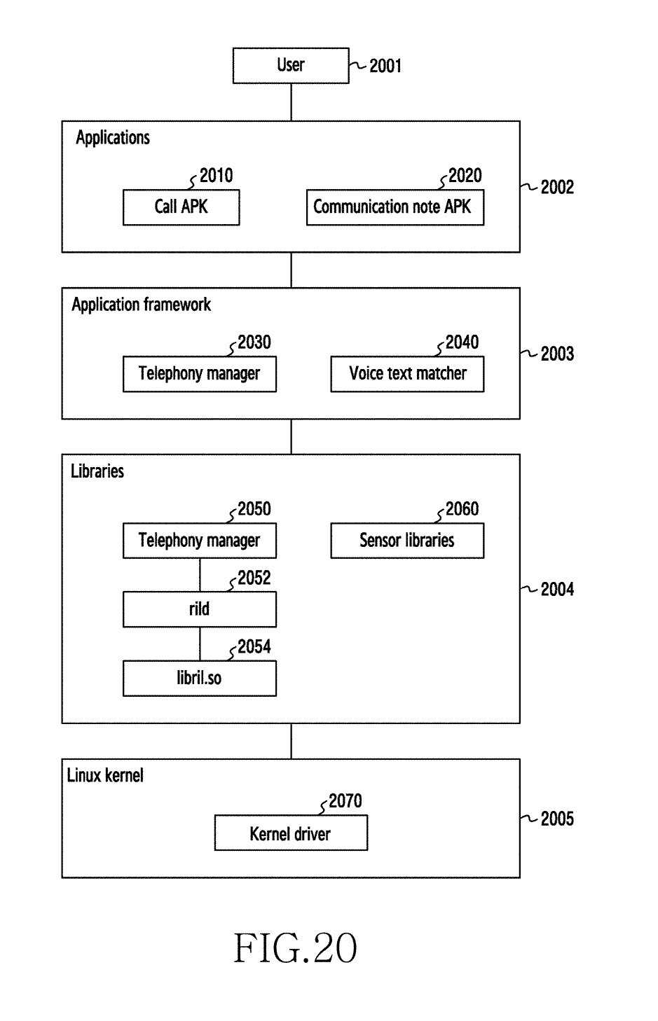

FIG. 20 illustrates a system for implementing the communication note, according to an embodiment of the present disclosure. In an embodiment, the system includes application 2002, application framework 2003, libraries 2004, and linux kernel 2005. The applications 2002 include call apk 2010 and communication note apk 2020. The application framework 2003 includes telephony manager 2030 and voice text matcher 2040. The libraries 2004 include telephony manager 2050, rild 2052, libril.so 2054 and sensor libraries 2060. The linux kernel 2005 includes kernel driver 2070. Application framework 2003 such as a telephony framework contains various functions. The telephony libraries contains the procedure to execute those functions. So, for any function the telephony manager 2030 in framework would call telephony manager 2050 in libraries which would execute those functions.

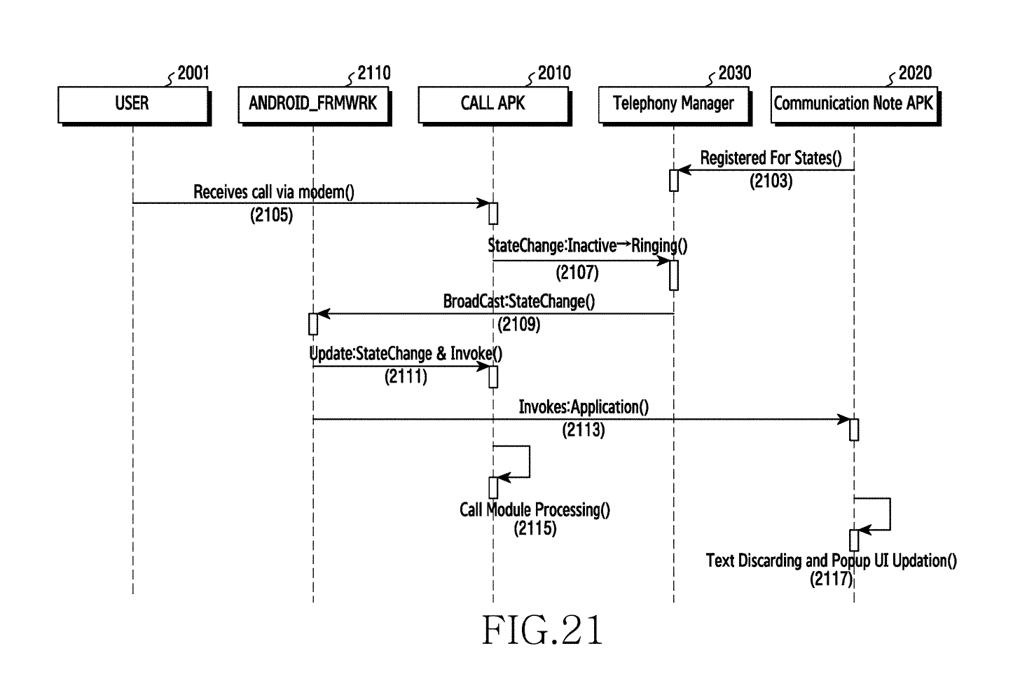

FIG. 21 illustrates a sequence diagram of scheme for implementing the communication note. At step 2103, communication note apk 2020 transmits a message of “Registered For States( )” to the telephony manager 2030. The “Registered For States( )” message signifies that when the communication note apk triggers. The states mean whether the communication notes are saved for incoming or outgoing call or both. Then, the telephony manager 2030 registers the communication note apk. At step 2105, the user 2001 receives a call via modem. Then, the user 2001 transmits a message of “Receives call via modem( )” to the call apk 2010. At step 2107, the call apk 2010 transmits a message of “StateChange: Inactive to Ringing” to the telephony manager 2030. In an example, the states are changed from inactive state to ringing state. The inactive state is for device which means it is in idle condition. The ringing state means a call is coming to the device. At step 2109, in another example, the states may be “Hook” and “Disconnected”. “Hook” means no call, “Disconnected” means ongoing call is disconnected. At step 2109, the telephony manager 2030 transmits a message of “Broadcast: StateChange( )” to an android_framework 2110. The android_framework is an example of the application framework 2003. In this step, the telephony manager 2030 broadcasts the states are changed. For example, the states change “Inactive” to “Ringing”. At step 2111, the android_framework 2110 transmits a message of “Update:StateChange & Invoke” to the call apk 2010. In this step, the android_framework 2110 updates the states are changed and invoke the call apk 2010. At step 2113, the android_framework 2110 transmits a message of “Invokes: Application( )”. In this step, the android_framework invokes the communication note apk 2020. At step 2115, the call apk 2010 transmits a message of “Call Module Processing( )” to itself. The “Call Module Processing” is the module which process call according to the states of the device. At step 2117, the communication note apk 2020 transmits a message of “Text Discarding and Popup UI Updation( )” to itself. In this step, the communication note apk 2020 discards the text discussed in call and displays a “POP UP UI”.

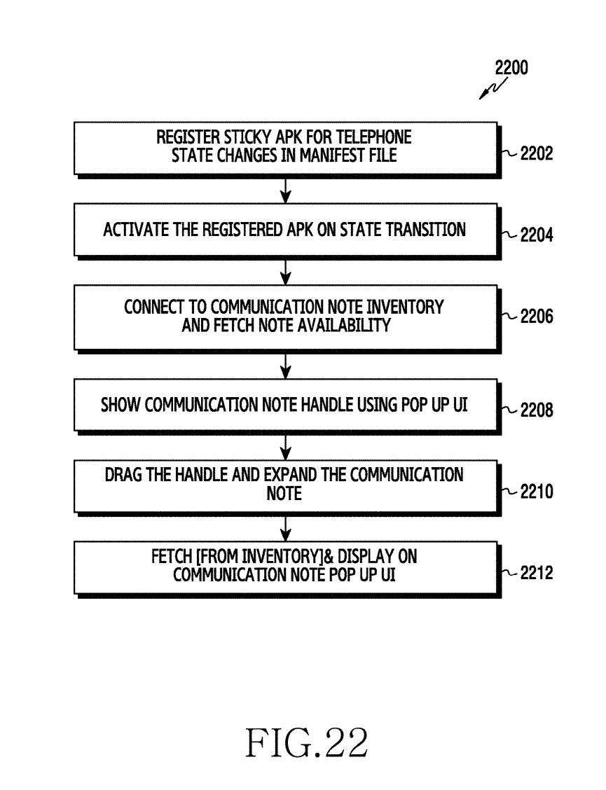

FIG. 22 is a flow diagram 2200 illustrating a method for implementing the communication note. FIG. 22 exemplifies a method for operating the electronic device 110a

Referring FIG. 22, at step 2202, the electronic device (i.e., telephony manager 2030 or processor 110) registers the communication note apk for telephony states changes in manifest file. At step 2204, the electronic device activates the registered communication note apk on the state transition. At step 2206, the electronic device connects to communication note inventory 108 and fetches availability information of the corresponding communication note. At step 2208, the electronic device shows a communication note handle using POP UP UI. At step 2210, the electronic device applies a drag listener on handle. The drag listener is a module which checks whether the drag action is performed to display the communication note. If the user 2001 drags the communication note, the communication note would be expanded. At step 2212, the electronic device fetches the display contents from the communication note inventory 108 and displays on POP UP UI.

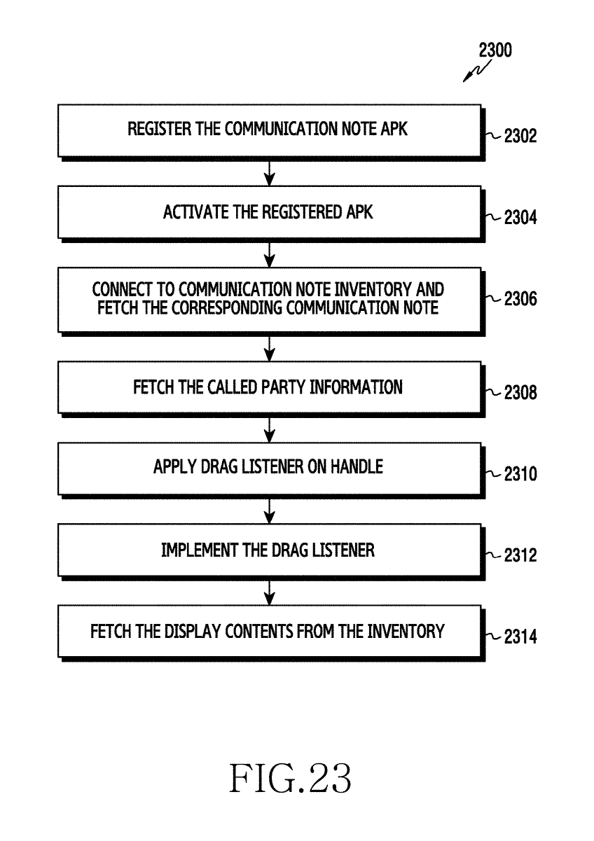

FIG. 23 is a flow diagram 2300 illustrating a method for implementing the communication note in the dual mode display of the communication note. The dual mode display shows caller side note and called party side note. Further, in the dual display mode, the called party may write in the caller side note so that it is visible to the caller side note. FIG. 23 exemplifies a method for operating the electronic device 110a

Referring FIG. 23, at step 2302, the electronic device (i.e., the telephony manager 2030 or the processor 110) registers the communication note apk for the telephony states changes in manifest file. At step 2304, the electronic device activates the registered communication note apk. At step 2306, the electronic device connects to communication note inventory 108 and fetches the corresponding communication note. At step 2308, the electronic device fetches the called party information. The called party information can be fetched by connecting 3G (3rd generation) network or by connecting to the server which act as a medium for data communication between two parties. At step 2310, the electronic device 2030 applies drag listener on handle. At step 2312, the electronic device 2030 implements the drag listener which will modify the POP UP UI as per dual display when 3G network is active and is expanded on dragging the handle. At step 2314, the telephony manager 2030 fetches the display contents from the communication note inventory for the caller party display on the POP UP UI and for called party from the connection to the server.

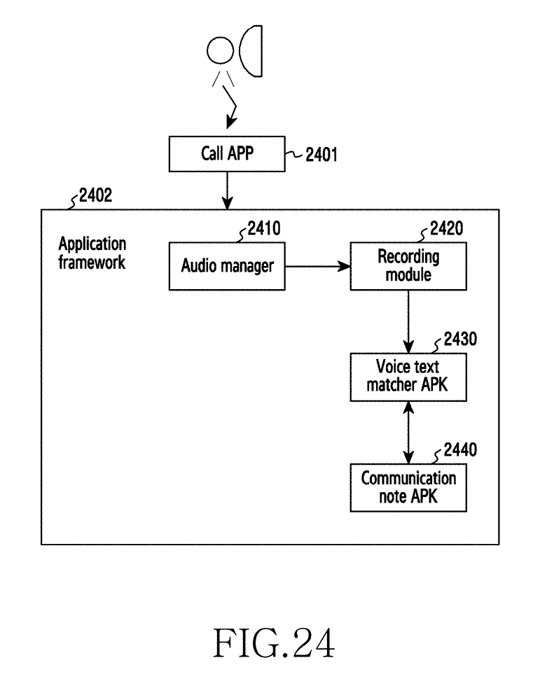

FIG. 24 illustrates a system for implementing voice contextual discarding. In an embodiment, the system includes call app 2401 and application framework 2402. The application framework 2403 includes audio manager 2410, recording module 2420, voice text matcher apk 2430 and communication note apk 2440. A user speaks on call, then the call app 2401 sets mode and stream type. In application framework 2402, the audio manager 2410 routes voice data to the recording module 2420, the recording module 2420 routes the voice data to the voice text matcher apk 2430. The voice text matcher apk 2430 parses and matches the voice data with reference text. Then, the voice text matcher apk 2430 broadcasts the communication note for updating and discarding the text. Then, the communication note apk 2440 broadcasts the updated text of the communication note.

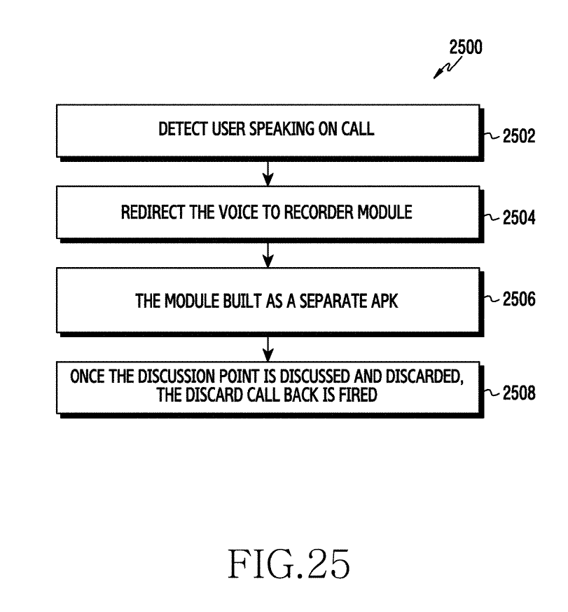

FIG. 25 is a flow diagram 2500 illustrating a method for implementing the voice contextual discarding. In an embodiment, the call is connected and dual communication notes are displayed on both the caller side and called party side. Further, the connection to the 3G network is active. FIG. 25 exemplifies a method for operating the electronic device 110a

Referring FIG. 25, at step 2502, the electronic device (i.e., the audio manager 2410 or the processor 110) detects the user speaking on the call and the call app 2401 sets mode and stream type. At step 2504, the electronic device redirects the voice to recording module 2420. At step 2506, the electronic device is built as a separate apk. The electronic device is connected to the recording module 2420. The recording module 2420 can be a discarding parser module which parses voice, understands the words spoken in the discussion and discards discussion point which is discussed over the phone. At step 2508, once the discussion point is discussed and discarded, the electronic device discards call back. The discard back is fired. This discard call back can delete the discussion point from UI and modify the POP UP UI. After these steps, if the user 2401 discussed completely and nothing remained in communication note, the communication note would keep shrinking and disappears.

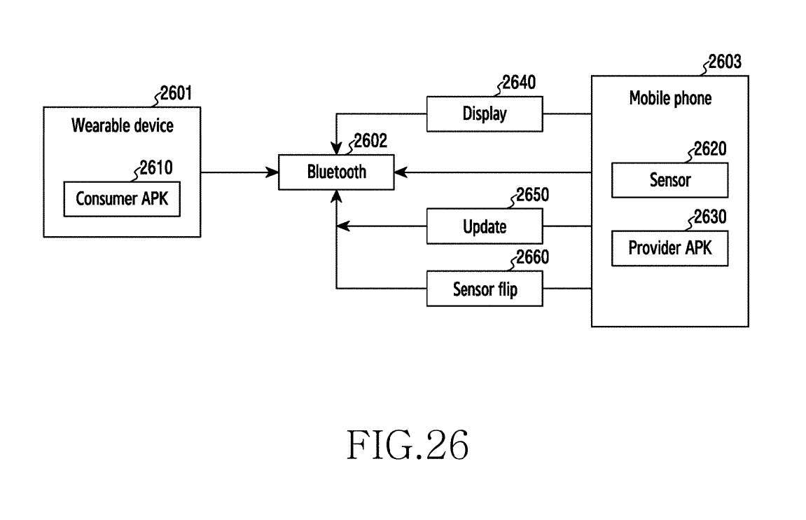

FIG. 26 illustrates a system for implementing the communication note with wearable device. Consumer apk 2610 can be installed in the wearable device 2601. Provider apk 2630 can be installed in the mobile phone. The wearable device 2601 and the mobile phone 2603 communicate via data channel over Bluetooth 2602. The message for the communication can be different types like display 2640, update 2650 and sensor flip 2660. Sensor 2620 on the mobile phone can be heart-beat or proximity sensor or camera blocking invocation.

The embodiments disclosed herein can be implemented through at least one software program running on at least one hardware device and performing network management functions to control the elements. The elements shown in the FIGS. 1 through 19 include blocks which can be at least one of a hardware device, or a combination of hardware device and software module.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for operating an electronic device, the method comprising:
establishing a call associated with a contact information stored in the electronic device;
retrieving at least one communication note comprising at least one data item for the contact information;
displaying the at least one communication note while the call is ongoing; and
changing the at least one communication note based on contents of conversation on the call.

2. The method of claim 1, wherein the changing of the at least one communication note comprises:
if the at least one data item is detected on the call, discarding the at least one data item from the at least one communication note based on the contents of the conversation while the call is ongoing.

3. The method of claim 1, wherein the changing of the at least one communication note comprises:
if at least one new data item is detected on the call, adding the at least one new data item to the at least one communication note based on the contents of the conversation while the call is ongoing.

4. The method of claim 1, further comprising:
detecting a user input for editing the communication note while the call is ongoing;
displaying an editing window on a screen of the electronic device;
detecting a data item through the editing window; and
adding the data item to the at least one communication note.

5. The method of claim 1,
wherein the displaying of the at least one communication note comprises displaying the at least one communication note according to a priority level, and
wherein the priority level is determined based on at least one of an amount of data items inputted by a user, a type of data items, or a combination of the same.

6. The method of claim 1, further comprising:
detecting a glide event for opening the communication note while the call is ongoing; and
if the glide event occurs on the closed communication note, displaying the communication note.

7. The method of claim 1, further comprising:
detecting that the call is disconnected;
identifying at least one remaining data item in the at least one communication note; and
transmitting, to at least one electronic device associated with the contact information, at least one message comprising the at least one remaining data item.

8. The method of claim 1, wherein the displaying of the at least one communication note further comprises:
displaying the at least one communication note on a first electronic device and on a second electronic device while the call is ongoing; and
editing the at least one communication note on the first electronic device and on the second electronic device while the call is ongoing.

9. The method of claim 1, further comprising:
detecting an input event on the electronic device; and
transmitting, to a wearable device, the at least one communication note,
wherein the electronic device is coupled to the wearable device.

10. The method of claim 9, further comprising:
displaying the at least one communication note on the wearable device; and
performing at least one action on the at least one communication note displayed on the wearable device,
wherein the at least one action comprises one or more blocking a proximity sensor.

11. An electronic device comprising:
a memory; and
at least one processor configured to:
establish a call associated with a contact information stored in the electronic device,
retrieve at least one communication note comprising at least one data item for the contact information,
display the at least one communication note while the call is ongoing, and
change the at least one communication note based on contents of conversation on the call.

12. The electronic device of claim 11, wherein the at least one processor is further configured to:
if the at least one data item is detected on the call, discard the at least one data item from the at least one communication note based on the contents of the conversation while the call is ongoing.

13. The electronic device of claim 11, wherein the at least one processor is further configured to:
if at least one new data item is detected on the call, add the at least one new data item to the at least one communication note based on the contents of the conversation while the call is ongoing.

14. The electronic device of claim 11, wherein the at least one processor is further configured to:
detect a user input for editing the communication note while the call is ongoing,
display an editing window on a screen of the electronic device,
detect a data item through the editing window, and
add the data item to the at least one communication note.

15. The electronic device of claim 11,
wherein the at least one processor is further configured to display the at least one communication note according to priority level, and
wherein the priority level is determined based on at least one of an amount of data items inputted by a user, a type of data items, or a combination of the same.

16. The electronic device of claim 11, wherein the at least one processor is further configured to:
detect a glide event for opening the communication note while the call is ongoing, and
if the glide event occurs on the closed communication note, display the communication note.

17. The electronic device of claim 11, wherein the at least one processor is further configured to:
detect that the call is disconnected,
identify at least one remaining data item in the at least one communication note, and
transmit, to at least one electronic device associated with the contact information, at least one message comprising the at least one remaining data item.

18. The electronic device of claim 11, wherein the at least one processor is further configured to:
display the at least one communication note on a first electronic device and on a second electronic device while the call is ongoing, and
edit the at least one communication note on the first electronic device and on the second electronic device while the call is ongoing.

19. The electronic device of claim 11,
wherein the electronic device is coupled to a wearable device, and
wherein the at least one processor is further configured to:
detect an input event on the electronic device, and
transmit, to the wearable device, the at least one communication note.

20. The electronic device of claim 19,
wherein the at least one processor is further configured to:
display the at least one communication note on the wearable device, and
perform at least one action on the at least one communication note displayed on the wearable device, and
wherein the at least one action comprises one or more blocking a proximity sensor.
